(19) United States
(12) Patent Application Publication
(10) Pub. No.: US 2013/0096942 A1
(43) Pub. Date: Apr. 18, 2013

(54) Discharge Decision Support System for Post Acute Care Referral

(71) Applicant: The Trustees of the University of Pennsylvania, Philadelphia, PA (US)

(72) Inventors: Kathryn H. Bowles, Fort Washington, PA (US); Mary D. Naylor, Newton Square, PA (US)

(73) Assignee: The Trustees of the University of Pennsylvania, Philadelphia, PA (US)

(21) Appl. No.: 13/652,055

(22) Filed: Oct. 15, 2012

Related U.S. Application Data
(60) Provisional application No. 61/547,521, filed on Oct. 14, 2011.

(51) Int. Cl. G06Q 50/22

(52) U.S. Cl. 705/2

(57) ABSTRACT

A system and method of recommending post-acute care services to a patient is described. The system and method include the steps of providing a plurality of questions relating to a patient, where each question has at least two selectable answers, and wherein each selectable answer has associated therewith a corresponding score, receiving one of the selectable answers for each of the plurality of questions, calculating a total score corresponding to the sum score of each of the answers selected, and generating a post-acute care referral if the total score meets a predetermined threshold value.

### CROSS-REFERENCE TO RELATED APPLICATIONS

This application claims the benefit of priority of U.S. Provisional Application No. 61/547,521 filed Oct. 14, 2011, the entire disclosure of which is incorporated by reference herein in its entirety.

### STATEMENT REGARDING FEDERALLY SPONSORED RESEARCH OR DEVELOPMENT

This invention was made with government support under RO1-NR007674, RO1-NR02095 and RO1-NR04315 awarded by the National Institutes of Health. The government has certain rights in the invention.

### BACKGROUND OF THE INVENTION

Hospital discharge planning is a frequently occurring and expensive hospital care process done annually for more than 13 million Medicare beneficiaries (Department of Health and Human Services. (2006). A profile of older Americans: 2006 Health and health care). The process has multiple steps that require a careful, comprehensive assessment to adequately determine a patient's present needs, and that anticipates future needs, makes appropriate referral decisions, and coordinate follow-up services. These factors result in the discharge of vulnerable elders who may go on to experience costly, poor health outcomes without follow-up care.

At the time of hospital discharge, clinicians are forced to make a decision whether or not to refer patients to post acute care services, which would allow them to remain in their homes safely and successfully. Short hospital stays, inconsistent assessment criteria, and varying levels of expertise and risk tolerance in decision-making often interfere with discharge planning. As a result, older patients leave the hospital with unmet needs (Mamon, et al., 1992, Health Serv Res 27:155-175), with as many as 26% of patients needing home care going home without it (Prescott et al., 1995, Res Nurs Health 18:85-95). In addition, several studies show that hospital clinicians do not recognize which patients are appropriate for home care (Arenth et al., 1985, Nurs Manage 16:20-24; Castro et al., 1998, J Emerg Nurs 24:127-132; Clemens et al., 1997, Home Health Care Serv Q 16:3-20; Magilvy et al., 1991, Home Health Care Serv Quart 12:59-70; Reilly et al., 1996, J Nurs Scholarsh. 28:143-159; Thomas et al., 1998, Home Health Care Serv Q 17:1-20). The abilities and needs of older patients are frequently missed especially for living arrangements, home environment, self-care ability, and availability and skill of caregivers (Arenth et al., 1985, Nurs Manage 16:20-24). Nurses consistently underestimate patients' functional disability and overestimate their understanding of treatment plans (Reilly et al., 1996, J Nurs Scholarsh. 28:143-159). Missed referrals also occur because of a process guided by a medical model, as defined by Medicare, which focuses on the functional limitations of patients, requires homebound status, and fails to consider the larger context of patients and their families (Pohl et al., 1995, Home Health Care Serv Q 15:33-47).

Several studies describe disparities in referral decision making and point to the importance of standardization and decision support for this important function. Patients living with a spouse were less than half as likely to be referred for skilled home care than those living with non-spouse caregivers (Diwan et al., 1997, Gerontologist, 37:169-181). Living alone assured 94% of the patients a visit by discharge planners while only 40% of those who lived with someone were visited (Furstenberg, et al., 1987, Comprehensive Gerontology, B 1(2):80-85). Disparities also exist by race, and gender. African Americans received significantly fewer hours of home care services (Chadiha et al., 1995, Gerontologist, 35, 233-239), fewer nursing home admissions (Morrow-Howell, et al., 1996, Health and Social Work, 21:131-139) and referrals to cardiac rehabilitation (Gregory, et al., 2006, Am J Phys Med Rehabil., 85:705-710) than whites. Women, with the same functional limitations as men, were only one-fourth as likely as men to be referred for home care (Pohl & Given, 1995, Home Health Care Services Quarterly 15(4):33-47). High risk patients and patients with unmet needs were not referred for home care as expected (Bowles, et al., 2002, Journal of the American Geriatrics Society, 50:336-342; Bowles, et al, 2008, Medical Care, 46:158-166). Discharge planning, transitions, and care coordination are important quality of care topics (National Quality Forum. (2006). Safe practices for better healthcare 2006), therefore studies that illuminate the issues and test interventions for improvement are greatly needed.

Although the volume of such decisions for hospitalized adults is high, there are no nationally recognized factors, or empirically derived decision support tools to assist discharge planners and others in making these important decisions. For example, a document titled Discharge Planning for the Older Adult (Zwicker D, Picariello G. (2003). Discharge planning for the older adult. In: M. Mezey, T. Fulmer Abraham, D. A. Zwicker (Eds). Geriatric nursing protocols for best practice. 2nd ed. (pp. 292-316). New York (NY): Springer Publishing Company, Inc.) offers a list of what should be assessed. However this document is not useful as a decision support tool because of its length and lack of synthesis or explicit recommendations to the user. Decision support in nursing is an understudied, but newly developing area of science. Because of this, there is a high rate of discharge variability, which results in missed referrals for those who may have benefited from post-acute care.

Thus, a need exists for a system and method for discharging hospitalized patients that includes a mechanism for determining whether or not to recommend a post-acute care referral. The present invention satisfies this need.

### SUMMARY OF THE INVENTION

A method of determining the need for a post-acute care service referral to a patient is described. The method includes the steps of providing a plurality of questions relating to a patient, wherein each question has at least two selectable answers, and wherein each selectable answer has associated therewith a corresponding score, receiving one of the selectable answers for each of the plurality of questions, calculating a total score corresponding to the sum score of each of the answers selected, and determining the need for a post-acute care referral based on whether the total score reaches a threshold value, wherein a total score above the threshold value is indicative of needing the post-acute care referral, and a total score at or below the threshold value is indicative of no need for a post-acute care referral.

In one embodiment, the plurality of questions relating to the patient are selected from the group consisting of the patient's Ability to Walk, Self Rated Health Assessment, Length of Stay, Age, Number of Co-Morbid Conditions and Depression Rating. In another embodiment, the plurality of questions relating to the patient include each of the patient's Ability to Walk, Self Rated Health Assessment, Length of Stay, Age, Number of Co-Morbid Conditions and Depression Rating. In further embodiment, the patient is cognitively intact or mildly cognitively impaired yet verbal. In another embodiment, the plurality of questions relating to the patient are selected from the group consisting of How Often a Caregiver is Available to Care for the Patient, Ability to Walk, Self Rated Health Assessment, Length of Stay, Number of Co-Morbid Conditions and Patient Income. In another embodiment, the plurality of questions relating to the patient include each of How Often a Caregiver is Available to Care for the Patient, Ability to Walk, Self Rated Health Assessment, Length of Stay, Number of Co-Morbid Conditions and Patient Income. In a further embodiment, the patient is severely cognitively impaired or cannot speak. In another embodiment, the method is executable on a computing device.

Also described is a system for recommending post-acute care services to a patient. The system includes providing a plurality of questions relating to a patient, wherein each question has at least two selectable answers, and wherein each selectable answer has associated therewith a corresponding score, receiving one of the selectable answers for each of the plurality of questions, calculating a total score corresponding to the sum score of each of the answers selected, and generating a post-acute care referral if the total score meets a predetermined threshold value.

Also described is an automated system for recommending post-acute care services to a patient. The automated system includes a computing device having resident therein a computer executable recommendation engine, wherein the recommendation engine presents to a user of the computing device a plurality of questions relating to a patient, wherein each question has at least two selectable answers, and wherein each selectable answer has associated therewith a corresponding score, such that when an answer is selected for each of the plurality of questions, a total score corresponding to the sum score of each of the answers is calculated, and a post-acute care referral is recommended for the patient if the total score meets a predetermined threshold value.

Also described is a method of reducing the rate of readmission of a patient to a healthcare facility. The method includes the steps of providing a plurality of questions relating to a patient being admitted to a healthcare facility, wherein each question has at least two selectable answers, and wherein each selectable answer has associated therewith a corresponding score, receiving one of the selectable answers for each of the plurality of questions, calculating a total score corresponding to the sum score of each of the answers selected, and determining the need for a post-acute care referral based on whether the total score reaches a threshold value, wherein a total score above the threshold value is indicative of needing the post-acute care referral, and a total score at or below the threshold value is indicative of no need for a post-acute care referral, wherein the determination of the need for a post-acute care referral alerts the discharge team of high risk patients to trigger better discharge planning and in some instances subsequently reduce the rate of readmission of the patient to a healthcare facility.

### BRIEF DESCRIPTION OF THE DRAWINGS

For the purpose of illustrating the invention, there are depicted in the drawings certain embodiments of the invention. However, the invention is not limited to the precise arrangements and instrumentalities of the embodiments depicted in the drawings.

FIG. 1 is a flow chart of an exemplary method of the present invention. The determination of question sets is based on the patient's ability to answer questions with or without the assistance of a representative.

FIG. 2 is a flow chart of an exemplary method, where the patient is cognitively intact or mildly cognitively impaired. Selectable answers to each question have exemplary score values, and a threshold value is set commensurate with the score values.

FIG. 3 is a flow chart of an exemplary method, where the patient is severely cognitively impaired or can't speak. Selectable answers to each question have exemplary score values, and a threshold value is set commensurate with the score values.

FIG. 4 is a chart depicting the time to readmission in the usual care phase by D²S² referral status as described in Example 3.

FIG. 5 is a chart depicting the time to readmission in the experimental phase by D²S² referral status as described in Example 3.

### DETAILED DESCRIPTION

It is to be understood that the figures and descriptions of the present invention have been simplified to illustrate elements that are relevant for a clear understanding of the present invention, while eliminating, for the purpose of clarity, many other elements found in hospital discharge decision systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform the disclosed methods.

“Post-acute services”, as used herein, means patient services such as skilled home care, outpatient rehabilitation, or admission to a nursing home or rehabilitation/skilled nursing facility.

A “post-acute referral” as used herein is a clinician or other healthcare professional recommendation to refer the patient for post-acute services.

A “length of stay”, as used herein, means the amount of time the patient is checked into a hospital or health care facility.

A “co-morbid condition”, as used herein, means one or more diseases or conditions that occur together with the primary condition.

A “patient”, as used herein, is a person who has received care at a hospital or other health care facility.

A “patient representative”, as used herein, is an agent, family member, proxy or a person other than the patient who can speak or answer for or on behalf of the patient.

A “subject”, as used herein, means either a patient or a patient representative.

“Cognitively intact”, as used herein, means the patient is awake, alert and oriented to person, place and time. Able to obtain a passing score on a cognitive screening test such as the mini-cog or mental status exam.

“Mildly cognitively impaired”, as used herein, means the patient may have some memory deficits or mild impairment on a cognitive screening test, but can converse and answer questions appropriately.

“Severely cognitively impaired”, as used herein, means the patient is non-verbal or too impaired to understand conversation or answer questions appropriately.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

The present invention relates to a mechanism for determining whether or not to recommend a post-acute care referral. The invention utilizes evidence-based decision support tools to reduce discharge variability and to identify older adults for post-acute services. The invention includes a multi-step data collection mechanism that formulates a discharge referral recommendation based on information items collected from the patient. The invention inputs this information into a scoring algorithm that results in a recommendation whether or not to refer that patient for post-acute care services. In one embodiment, the invention includes a post-acute care recommendation engine, operating as a fully automated software platform that can be executed by any stationary, portable, networked or stand-alone computing device. In other embodiments, the invention can be partially embodied within a software platform, while selected procedural steps are executed manually. The invention can also be integrated into other hospital system databases, such that selected patient records or other information items within the hospital system can be collected and used in the determination, or can be used to populate and report to the system databases, all in a manner that is compliant with HIPAA regulations.

As mentioned previously, the present invention includes a multi-step data collection system that provides decision support for clinicians formulating a discharge plan, or for clinicians determining whether or not to refer a patient for post-acute services, based on information items collected from the patient, a patient representative or proxy, the hospital or health care facility, or from a database of existing data or other records. For example, and without limitation, the information items may correspond to the patient's age, walking ability, length of stay, number of co-morbid conditions, depression rating, self-rated health assessment, how often a caregiver is available for the patient, and even patient income. It should be appreciated that other factors, as would be understood by those skilled in the art, may be incorporated into the collected information items without departing from the spirit of the present invention. It should also be appreciated that the present invention is not limited to any particular combination of factors, or weighting of factors, in determining the discharge plan and/or recommendation for post-acute care services.

For example, the information item may relate to the patient's ability to walk. In some embodiments, this information item may be broken down into descriptive categories of the patient's ability to walk. Such categories may include, without limitation: no restrictions; minor restrictions or changes; walks with the help of equipment; major restrictions; daily assistance from another person; or does not walk or otherwise unable to take steps.

In another example, the information item may relate to the patient's age. In some embodiments, this information item may be broken down into descriptive categories of the patient's age (in years). Such categories may include, without limitation: <90; <85; <80; <70; <65; <60; <55; <50; 50+; 55+; 60+; 65+; 70+; 80+; 85+; and 90+.

In another example, the information item may relate to the patient's length of stay. In some embodiments, this information item may be broken down into descriptive categories of the patient's length of stay (in days). Such categories may include, without limitation: 0-1; 0-2; 0-3; 0-4; 0-5; 0-6; 0-7; 0-8; 0-9; 0-10; 2-4; 3-5; 4-7; 0; 1; 2+; 3+; 4+; 5+; 6+; 7+; 8+; 9+; 10+; and 11+.

In another example, the information item may relate to the patient's number of co-morbid conditions. In some embodiments, this information item may be broken down into descriptive categories of the patient's number of co-morbid conditions. Such categories may include, without limitation: 0; 0-1; 2-3; 3-5; 1+; 2+; 3+; 4+; and 5+.

In another example, the information item may relate to the patient's depression rating. In some embodiments, this information item may be broken down into descriptive categories of the patient's depression rating (Yes/No answer to question). Such categories may include, without limitation: “During the past month, have you often been bothered by feeling down, depressed, or hopeless?” (Yes/No); and “During the past month, have you often been bothered by little interest or pleasure in doing things?” (Yes/No).

In another example, the information item may relate to the patient's self rated health assessment. In some embodiments, this information item may be broken down into descriptive categories of the patient's self rated health assessment. Such categories may include, without limitation: excellent; good; average; fair; and poor.

In another example, the information item may relate to how often a caregiver is available to care for the patient. In some embodiments, this information item may be broken down into descriptive categories of the caregiver's availability. Such categories may include, without limitation: never; infrequently; occasionally; often; whenever needed; 2 hour/day; 4; hours/day; 6 hours/day; 8 hours/day; full-time; 1 day/week; 2 days/week; 3 days/week; 4 days/week; 5 days/week; 6 days/week; and 7 days/week.

In another example, the information item may relate to the patient's income. In some embodiments, this information item may be broken down into descriptive categories of the patient's income (annual). Such categories may include, without limitation: <$15,000; <$20,000; <$25,000; <$30,000; <$35,000; <$40,000; <$45,000; <$50,000; $15,000+; $20,000+; $25,000+; $30,000+; $35,000+; $40,000+; $45,000+; $50,000+.

In certain embodiments, the system is designed for cognitively intact or mildly cognitively impaired patients that remain verbal. In such embodiments, the system may collect the information items directly from the patient, such as by a verbal or written response from the patient, or indirectly, such as from the patient's representative. For some factors, the information items can be collected from an existing database, or from the hospital or health care facility. In other embodiments, the system is designed for severely cognitively impaired patients, or for patients that cannot effectively speak or communicate. In these embodiments, the system may collect the information items only indirectly, such as by a verbal or written response from the patient's representative, from an existing database, or from the hospital or health care facility.

The system of the present invention may also include a scoring metric, or algorithm, by which to weight each information item category in the system, and to calculate a value that is determinative of a recommendation for post-acute care services. It should be appreciated that the values designated for each information item category may vary according to the target patient group for which post-acute care services are to be reccommended. Further, the number or combination of information item categories will also effect the values designated. Further, the final score of the system may be set as a threshold value, where a score of equal to or above a designated value indicates that post-acute care services should be recommended for that patient. Alternatively, final score ranges can be used to designate categories such as: no post-acute care reccommended; perform secondary review by expert or clinician; and post-acute care reccommended. It should be appreciated that the system of the present invention is not limited to any predetermined value, number or other nomenclature.

For example, in one embodiment, the information item may relate to the patient's ability to walk, with descriptive categories of the patient's ability to walk being the following categories and having the corresponding raw score:

| Ability to Walk | Score |
|---|---|
| no restrictions | 0 |
| minor restrictions or changes | 0.5 |
| walks with the help of equipment | 2 |
| major restrictions/daily assistance from another person | 2 |
| does not walk or otherwise unable to take steps | 2 |

In another example, the information item may relate to the patient's age, with descriptive categories of the patient's age being the following categories and having the corresponding raw score:

| Age in Years | Score |
|---|---|
| Less than 80 | 0 |
| 80 or older | 1.5 |

In another example, the information item may relate to the patient's length of stay, with descriptive categories of the patient's length of stay being the following categories and having the corresponding raw score:

| Length of Stay in Days | Score |
|---|---|
| 0-7 | 0 |
| 8+ | 3 |

In another example, the information item may relate to the patient's number of co-morbid conditions, with descriptive categories of the patient's number of co-morbid conditions being the following categories and having the corresponding raw score:

| Number of Co-Morbid Conditions | Score |
|---|---|
| 0-1 | 0 |
| 2-3 | 0.5 |
| 4+ | 1 |

In another example, the information item may relate to the patient's depression rating, with descriptive categories of the patient's depression rating being the following categories and having the corresponding raw score:

| Depression Rating or Screening | Score |
|---|---|
| Q1 = “During theh past month, have you often been bothered | YES/NO |
| by feeling down, depressed, or hopeless?” | |
| Q2 = “During the past month, have you often been bothered | YES/NO |
| by little interest or pleasure in doing things?” | |
| SCORING | N/A |
| If NO to both Q1 and Q2 | 0 |
| If YES to Q1 and NO to Q2 | 1 |
| If NO to Q1 and YES to Q2 | 0.5 |
| IF YES to both Q1 and Q2 | 2 |

In another example, the information item may relate to the patient's self rated health assessment, with descriptive categories of the patient's self rated health assessment being the following categories and having the corresponding raw score:

| Self Rated Health Assessment | Score |
|---|---|
| excellent | 0 |
| good | 1 |
| fair or poor | 1.5 |

As explained previously, a designated total score value can be used as a threshold for whether post-acute care services are recommended. For example, in a system for cognitively intact patients or patients that are mildly cognitively impaired (yet verbal), where the aforementioned raw score values correspond to the aforementioned categories within information items for: Ability to Walk; Self Rated Health Assessment; Length of Stay; Age; Number of Co-Morbid Conditions; and Depression Screening, a Total Score of greater than 3 is determinative that post-acute care services should be recommended.

In yet another example, in a system for severely cognitively impaired patients or patients that cannot speak, the following information item categories and corresponding raw score can be used:

| How Often a Caregiver is Available to Care for the Patient | Score |
|---|---|
| never | 1 |
| infrequently | 1 |
| occasionally | 1 |
| often | 1 |
| whenever needed | 0 |

| Patient Annual Income | Score |
|---|---|
| Less than $20,000 | 1 |
| $20,000 or more | 0 |

| Ability to Walk | Score |
|---|---|
| no restrictions | 0 |
| minor restrictions or changes | 0.5 |
| walks with the help of equipment | 2 |
| major restrictions/daily assistance from another person | 2 |
| does not walk or otherwise unable to take steps | 2 |

| Length of Stay in Days | Score |
|---|---|
| 0-7 | 0 |
| 8+ | 3 |

| Number of Co-Morbid Conditions | Score |
|---|---|
| 0-1 | 0 |
| 2-3 | 0.5 |
| 4+ | 1 |

| Self Rated Health Assessment | Score |
|---|---|
| excellent | 0 |
| good | 1 |
| fair or poor | 1.5 |

Here, a designated total score value can be used as a threshold for whether post-acute care services are recommended, where the aforementioned raw score values correspond to the aforementioned categories within information items for: How Often a Caregiver is Available to Care for the Patient; Patent Income; Ability to Walk; Self Rated Health Assessment; Length of Stay; and Number of Co-Morbid Conditions, a Total Score of greater than or equal to 3 is determinative that post-acute care services should be recommended.

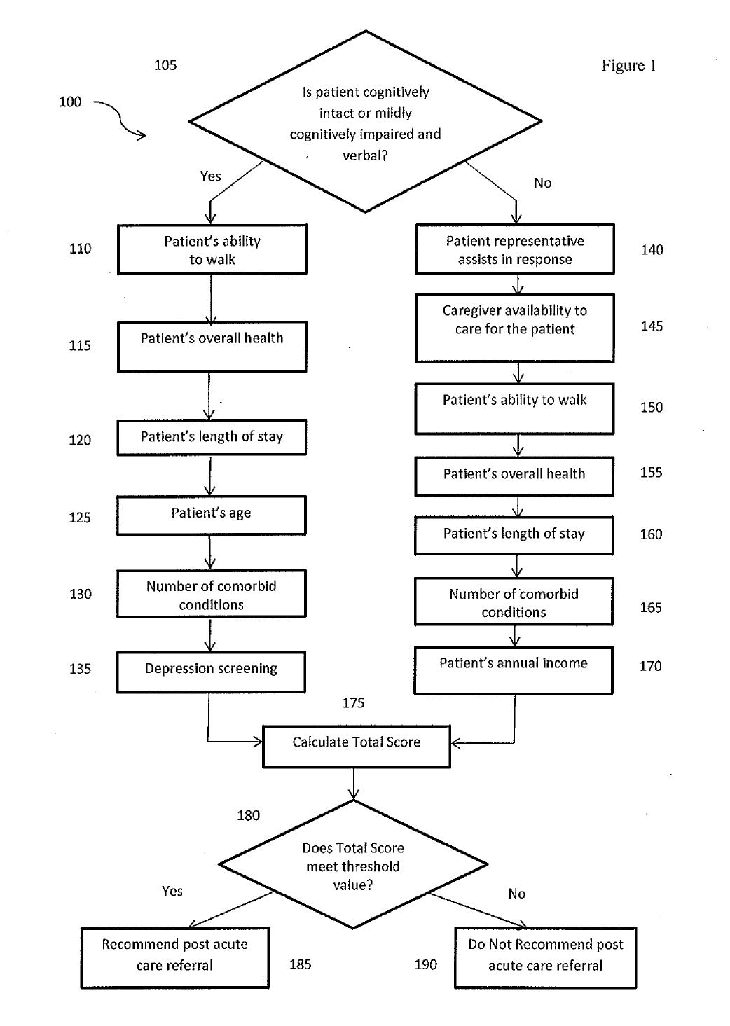

Referring now to FIG. 1, a flow chart of an exemplary method 100 of the present invention is illustrated. At step 105, it is first determined whether or not the patient is cognitively intact, or at least mildly cognitively impaired and verbal. If the patient is cognitively intact, or at least mildly cognitively impaired and verbal, then answers are selected to the question sets depicted generally in boxes 110, 115, 120, 125, 130 and 135 (selectable answers and associated score values not shown). If the patient is not cognitively intact, or at least mildly cognitively impaired and verbal, then a patient representative may assist in the selection of answers 140, and answers are selected to the question sets depicted generally in boxes 145, 150, 155, 160, 165 and 170 (selectable answers and associated score values not shown). In either case, the total score of the answers selected from the question set is calculated 175, and compared against a predetermined threshold value for the question set 180. If the total score meets the threshold value, a post-acute care referral for the patient is recommended 185. If the total score does not meet the threshold value, a post-acute care referral is not recommended for the patient 190.

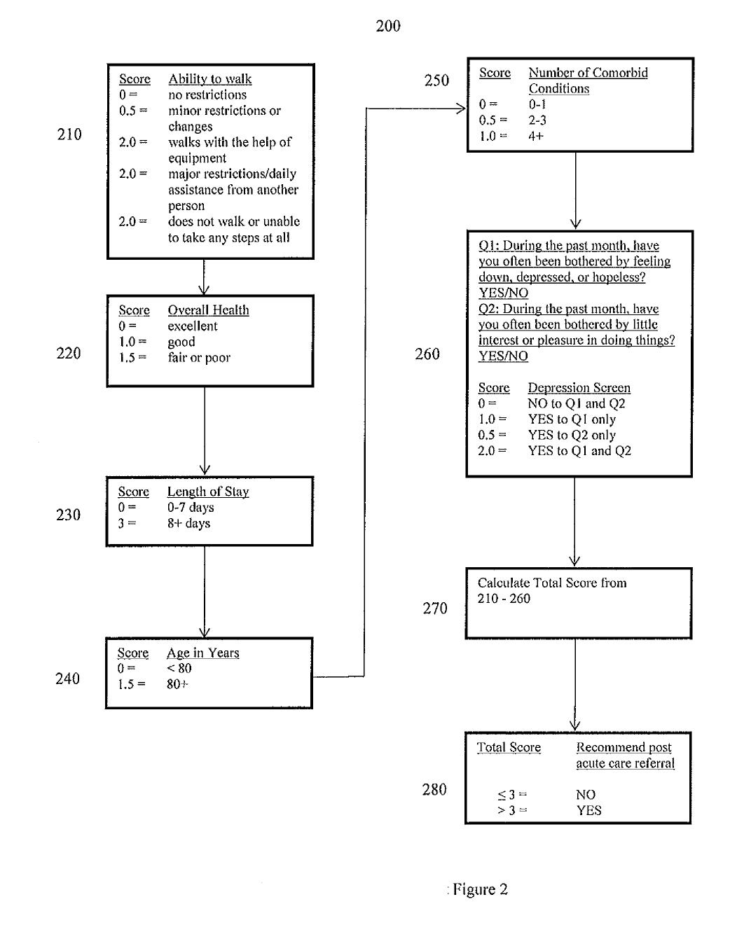

Referring now to FIG. 2, a flow chart of an exemplary question set and scoring mechanism 200 is illustrated, where the patient is cognitively intact or mildly cognitively impaired. At 210, the patient's ability to walk is assessed, where five selectable answers are provided, and each answer has associated therewith a score value. At 220, the patient's overall health is assessed, where three selectable answers are provided, and each answer has associated therewith a score value. At 230, the patient's length of stay in the healthcare facility is determined, where two selectable answers are provided, and each answer has associated therewith a score value. At 240, the patient's age is determined, where two selectable answers are provided, and each answer has associated therewith a score value. At 250, the patient's number of comorbid conditions is determined, where three selectable answers are provided, and each answer has associated therewith a score value. At 260, the patient's level of depression is assessed, where two questions are asked that require a YES or NO answer, and a score value is determined on the answers provided to both questions. At 270, the total score of each of blocks 210, 220, 230, 240, 250 and 260 is summed, and at 280 this total score is compared to a predetermined threshold value (in this case, the predetermined threshold value is 3). If the total score is less than or equal to 3, no post-acute care referral is recommended for the patient. If the total score is greater than 3, a recommendation for an post-acute care referral is made.

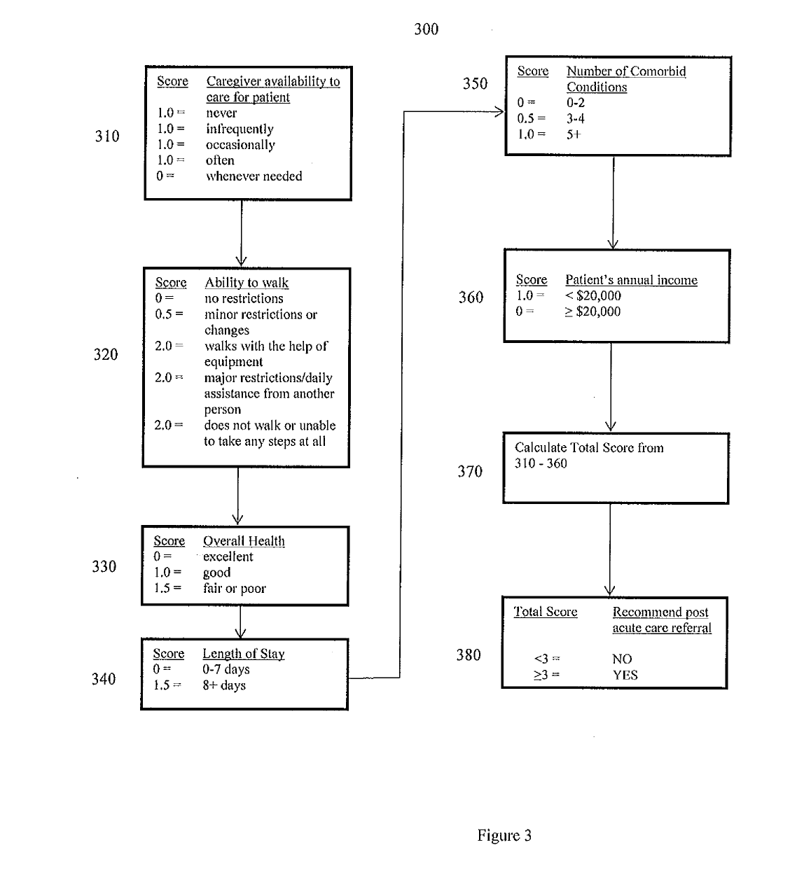

Referring now to FIG. 3, a flow chart of an exemplary question set and scoring mechanism 300 is illustrated, where the patient is not cognitively intact or mildly cognitively impaired. In this example, the patient may actually be severely cognitively impaired or can't speak, and therefore a representative may be used to assist in the selection of answers to each question in the question set. At 310, the availability of a caregiver for the patient is assessed, where five selectable answers are provided, and each answer has associated therewith a score value. At 320, the patient's ability to walk is assessed, where five selectable answers are provided, and each answer has associated therewith a score value. At 330, the patient's overall health is assessed, where three selectable answers are provided, and each answer has associated therewith a score value. At 340, the patient's length of stay in the healthcare facility is determined, where two selectable answers are provided, and each answer has associated therewith a score value. At 350, the patient's number of comorbid conditions is determined, where three selectable answers are provided, and each answer has associated therewith a score value. At 360, the patient's annual income is determined, where two selectable answers are provided, and each answer has associated therewith a score value. At 370, the total score of each of blocks 310, 320, 330, 340, 350 and 360 is summed, and at 380 this total score is compared to a predetermined threshold value (in this case, the predetermined threshold value is 3). If the total score is less than 3, no post-acute care referral is recommended for the patient. If the total score is greater than or equal to 3, a recommendation for an post-acute care referral is made.

In certain embodiments, additional questions or question sets may be utilized post-application of the tool. For example, such questions as, “Do you agree or not with the tool?” may be asked to one or more of the patient, patient representative or healthcare provider. Such post-application questions can assist in determining the effectiveness of the tool and provide feedback that can be later used to alter or adapt the tool in subsequent use with the same or different patients.

As contemplated herein, the system and methods of the present invention may be deployed or otherwise utilized, in whole or in part, at any point during a patient's stay in a healthcare facility. For example, the system may be used at the time of patient admission or as forming part of the admission protocol of the healthcare facility. In some embodiments, all question sets of the tool may be addressed at the time of admission, or in other embodiments, only selected questions sets of the tool may be addressed at the time of admission. In other embodiments, the system may be used at any point during the course of the patient's stay post-admission. In other embodiments, the system may be used at the time of patient checkout, or as forming part of the patient checkout protocol. It should be appreciated that there is no limitation to the timing of deployment of all or any portion of the tool during the course of patient stay at the healthcare facility.

It should also be appreciated that the system and methods of the present invention not only determine the need for post-acute care service referrals, but further reduces the number readmission events via extending the timing of patient readmissions to a healthcare facility. For example, the present invention can extend the time to readmission for patients, including high risk patients, by decreasing the relative rates of readmission by at least 10%, and more preferably by at least 15%, by at least 20% or even by at least 25%. Such decrease in the rate of readmission ultimately results in the reduction of total, whole number readmissions on a per-patient basis.

According to an aspect of the present invention, the system of the present invention may operate on a computer platform, such as a local or remote executable software platform, or as a hosted internet or network program or portal. In certain embodiments, only portions of the system may be computer operated, or in other embodiments, the entire system may be computer operated. As contemplated herein, any “computer platform” may be operable form any computing device as would be understood by those skilled in the art, including desktop or mobile devices, laptops, desktops, tablets, smartphones or other wireless digital/cellular phones, televisions or other thin client devices.

For example, the computer operable component(s) of the system may reside entirely on a single computing device, or may reside on a central server and run on any number of end-user devices via communications network. The computing devices may include at least one processor, standard input and output devices, as well as all hardware and software typically found on computing devices for storing data and running programs, and for sending and receiving data over a network, if needed. If a central server is used, it may be one server or, more preferably, a combination of scalable servers, providing functionality as a network mainframe server, a web server, a mail server and central database server, all maintained and managed by an administrator or operator of the system. The computing device(s) may also be connected directly or via a network to remote databases, such as for additional storage backup, and to allow for the communication of files, email, software, and any other data format between two or more computing devices. The communications network can be a wide area network and may be any suitable networked system understood by those having ordinary skill in the art, such as, for example, an open, wide area network (e.g., the internet), an electronic network, an optical network, a wireless network, a physically secure network or virtual private network, and any combinations thereof. The communications network may also include any intermediate nodes, such as gateways, routers, bridges, internet service provider networks, public-switched telephone networks, proxy servers, firewalls, and the like, such that the communications network may be suitable for the transmission of information items and other data throughout the system.

Further, the communications network may also use standard architecture and protocols as understood by those skilled in the art, such as, for example, a packet switched network for transporting information and packets in accordance with a standard transmission control protocol/Internet protocol (“TCP/IP”). Any of the computing devices may be communicatively connected into the communications network through, for example, a traditional telephone service connection using a conventional modem, an integrated services digital network (“ISDN”), a cable connection including a data over cable system interface specification (“DOCSIS”) cable modem, a digital subscriber line (“DSL”), a T1 line, or any other mechanism as understood by those skilled in the art. Additionally, the system may utilize any conventional operating platform or combination of platforms (Windows, Mac OS, Unix, Linux, Android, etc.) and may utilize any conventional networking and communications software as would be understood by those skilled in the art.

To protect data and to assist in complying with HIPAA regulations, an encryption standard may be used to protect files from unauthorized interception over the network. Any encryption standard or authentication method as may be understood by those having ordinary skill in the art may be used at any point in the system of the present invention. For example, encryption may be accomplished by encrypting an output file by using a Secure Socket Layer (SSL) with dual key encryption. Additionally, the system may limit data manipulation, or information access. For example, a system administrator may allow for administration at one or more levels, such as at an individual user (patient) level, a healthcare professional level, or at a system level. A system administrator may also implement access or use restrictions for users at any level. Such restrictions may include, for example, the assignment of user names and passwords that allow the use of the present invention, or the selection of one or more data types that the subservient user is allowed to view or manipulate.

As mentioned previously, the system may operate as application software, which may be managed by a local or remote computing device. The software may include a software framework or architecture that optimizes ease of use of at least one existing software platform, and that may also extend the capabilities of at least one existing software platform. The application architecture may approximate the actual way users organize and manage electronic files, and thus may organize use activities in a natural, coherent manner while delivering use activities through a simple, consistent, and intuitive interface within each application and across applications. The architecture may also be reusable, providing plug-in capability to any number of applications, without extensive re-programming, which may enable parties outside of the system to create components that plug into the architecture. Thus, software or portals in the architecture may be extensible and new software or portals may be created for the architecture by any party.

The system software may provide, for example, applications, such as the aforementioned discharge decision support and post-acute care service referral recommendations, accessible to one or more users to perform one or more functions. Such applications may be available at the same location as the user, or at a location remote from the user. Each application may provide a graphical user interface (GUI) for ease of interaction by the user with information resident in the system. A GUI may be specific to a user, set of users, or type of user, or may be the same for all users or a selected subset of users. The system software may also provide a master GUI set that allows a user to select or interact with GUIs of one or more other applications, or that allows a user to simultaneously access a variety of information otherwise available through any portion of the system.

The system software may also be a portal that provides, via the GUI, remote access to and from the system of the present invention. The software may include, for example, a network browser, as well as other standard applications. The software may also include the ability, either automatically based upon a user request in another application, or by a user request, to search, or otherwise retrieve particular data from one or more remote points, such as on the internet. The software may vary by user type, or may be available to only a certain user type, depending on the needs of the system. Users may have some portions, or all of the application software resident on a local computing device, or may simply have linking mechanisms, as understood by those skilled in the art, to link a computing device to the software running on a central server via the communications network, for example. As such, any device having, or having access to, the software may be capable of uploading, or downloading, any information item or data collection item, or informational files to be associated with such files.

Presentation of data through the software may be in any sort and number of selectable formats. For example, a multi-layer format may be used, wherein additional information is available by viewing successively lower layers of presented information. Such layers may be made available by the use of drop down menus, tabbed pseudo manila folder files, or other layering techniques understood by those skilled in the art. Formats may also include AutoFill functionality, wherein data may be filled responsively to the entry of partial data in a particular field by the user. All formats may be in standard readable formats, such as XML. The software may further incorporate standard features typically found in applications, such as, for example, a front or “main” page to present a user with various selectable options for use or organization of information item collection fields.

The system software may also include standard reporting mechanisms, such as generating a printable results report, or an electronic results report that can be transmitted to any communicatively connected computing device, such as a generated email message or file attachment. Likewise, particular results of the aforementioned discharge decision and post-acute referral can trigger an alert signal, such as the generation of an alert email, text or phone call, to alert an expert, clinician or other healthcare professional of the particular results.

### EXPERIMENTAL EXAMPLES

The invention is now described with reference to the following Examples. These Examples are provided for the purpose of illustration only and the invention should in no way be construed as being limited to these Examples, but rather should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore, specifically point out the preferred embodiments of the present invention, and are not to be construed as limiting in any way the remainder of the disclosure.

### Example 1

### Identification of Patients at Risk For Poor Discharge Outcomes

Referral decisions and 12-week outcomes of hospitalized older adults were examined to illustrate an opportunity to improve quality and cost outcomes by effectively identifying patients needing post discharge referrals. Discharge referral decisions of a panel of experts were compared to hospital clinicians' referral decisions for the same group of elderly patients. Further, 12 week outcomes for patients who experts identified for referral but were not referred by hospital clinicians were compared to those who experts and clinicians agreed to refer or not.

### Example 1 Methods

A comparative, descriptive study was conducted using existing and prospectively collected data on 355 hospitalized patients. Case studies, generated from hospital and research records, were judged by a panel of 8 experts to elicit their decisions on the need for a post discharge referral. The experts' decisions were compared to the referral decisions of hospital clinicians for these same patients. Outcomes 12 weeks after discharge were compared among elderly patients who experts said to refer, but who were not referred by hospital clinicians (Yes/No) to those where the experts' and clinicians' decisions agreed (Yes/Yes or No/No).

For the purposes of this study, a referral for post discharge care was defined as a recommendation made by the evaluating expert or hospital clinician (for example, a nurse, physical therapist, social worker, or physician) that the patient be referred for skilled home care, outpatient or inpatient rehabilitation, or admission to a nursing home.

### Experts

To gain national and local perspectives, 4 nationally recognized scholars and 4 respected hospital clinicians experienced in discharge planning representing the disciplines of nursing, social work, physical therapy, and medicine participated as experts in this investigation. Selection of the national scholars was based on their published record of scholarly work in discharge planning and outcomes research. The clinicians were selected based on recommendations from managers or peers and at least 5 years of experience in the field. Decision analysis groups typically consist of 6-12 members (Golden BL, Wasil EA, Harker PT. The Analytic Hierarchy Process. New York: Springer-Verlag Berlin Heidelberg; 1989).

### Data Sources

Data came from the control groups in 3 previously completed studies (N=208) and subjects enrolled for this investigation (N=147). The prior studies were used because they provided a rich database of consistent information describing the characteristics of hospitalized patients, the course of their stay, their outcomes, and they represented usual care.

A list of control group subjects was generated from 3 completed studies (N=443) conducted at 1 of 6 hospitals representing urban, suburban and rural settings: Study 1-“Comprehensive Discharge Planning for the Elderly, #1 RO1-NR02095, Study 2-“Comprehensive Discharge Planning for the Elderly, #1 RO1-NR02095, Study 3—“Home Follow-Up of Elderly Patients with Heart Failure”, #1 RO1-NR04315. A paper medical record and a research record containing baseline and 12-week follow-up data were prepared for each subject.

Records were chosen using a table of random numbers until 245 records were reached. The minimum number of cases required for this analysis was calculated to be 100 using the standard error associated with the area under the curve (AUC) statistic. Assuming an anticipated concordance of 0.80, the total number of cases would be 100 (50 referral+50 non-referral) for a standard error of 0.045 (Hanley et al., 1982, Radiology 143:29-36). However, based on prior work (Bowles et al., 2002, J Am Geriatr Soc 50:336-342), where the majority of patients were referred by experts, a larger sample than projected was drawn to assure enough non-referral types. Thirty-seven records were removed for the following reasons: missing data about the post-operative course or 12 week follow-up (N=21); subjects withdrew (N=5) or moved (N=1); data were not readable (N=3); the cases did not add anything new (N=5); or used to train the medical records abstractors (N=5). The principal investigator and a nursing graduate student research assistant read through each randomly chosen record. Included records contained a description of the course of hospital events, the discharge plan, admission and discharge medications, and the 12-week follow-up information.

### Study Sample

Study subjects were 65 and older, English-speaking, and scored 6 or more on the Short Portable Mental Status Questionnaire (Purser et al., 2006, J Am Geriatr Soc 54:335-338). Subjects in Study 1 had heart failure, angina, myocardial infarction, valve replacement, or coronary artery bypass surgery. Study 2 subjects had angina, myocardial infarction, congestive heart failure, respiratory infection, coronary artery bypass graft, cardiac valve replacement, major small or large bowel surgical procedure, or orthopaedic procedures of the lower extremities. In addition, patients enrolled in Study 2 met at least one of the following criteria found to be associated with poor discharge outcomes: age 80 or older; inadequate social support system; multiple, active, chronic health problems; history of depression; moderate to severe functional limitation; multiple hospitalizations during prior 6 months; any hospitalization in the past; fair or poor self-rating of health; or history of non-adherence to the treatment regimen (Naylor et al., 1999, JAMA 281:613-620). Study 3 subjects met the same criteria as those in Study 2, and were all admitted for heart failure.

Another 147 patients were enrolled and followed for 12 weeks as a purposive convenience sample from a rural community hospital (N=97) and an urban AMC tertiary referral center (N=50), both sites used in previous clinical trials. These subjects met the same inclusion criteria except for diagnoses and they did not have to meet the criteria associated with poor discharge outcomes. These additional cases were sought based on experts' suggestions to seek more variety in diagnoses and acuity. The prospective cases had diagnoses including cancer, diabetes, infection, genitourinary conditions, and traumatic injury. Heart failure and angina were excluded because these diagnostic categories were amply represented in the existing dataset. The new cases were mixed in with the others before presenting them to the experts.

### Data Collection Procedure

The following baseline data were consistently collected across all of the prior studies and from the prospective subjects during hospital admission: sociodemographic factors (age, race, gender, income, education level, living arrangement, health insurance); medical diagnosis; co-morbid conditions; adverse events during hospitalization; admission and discharge medications; previous home care use or hospitalization in last 6 months or 30 days; use of assistive devices; and patient's perception of need for assistive devices or services post discharge. Self-rated health status and functional status were collected baseline and 12 weeks after discharge. Discharge referral data, including hospital clinician and experts' recommendations and sites of referral, and resource utilization data including occasions and reasons for hospital readmissions, emergency department (ED) visits, and acute care visits to physicians were collected via patient records and telephone interviews up to 12 weeks after discharge. These data were validated by patients' physicians and hospital and home health agency records. RA's collected all data. The 12-week data point was chosen because it is a common data collection point across all 3 studies and it falls within the period when failure of discharge planning becomes evident (Potthoff S J, Kane R L, Franco S J. Hospital Discharge Planning for elderly patients: Improving Decisions, aligning incentives. 1985 (Master Contract 500-92-0048)).

### Outcome Measures

Referral decisions, including hospital clinicians' and experts' yes or no recommendations and sites of referral, were collected via patient records. These data were validated by patients' physicians and hospital and home health agency records.

Self-rated health status is the patient's perception of their overall health. It is measured by asking, “How is your overall health now? Is it excellent, good, fair, or poor?” (Maddox et al., 1973, J Health Soc Behav 14:87-93)

Functional Status was measured by the Enforced Social Dependency Scale (ESDS) (Benoliel et al., 1980, Res Nurs Health 3:3-10). Enforced social dependency means needing help or assistance from others when performing activities or roles that adults can usually do alone. This instrument measures: 1) personal competency, including a patient's function regarding eating, dressing, walking, traveling, bathing, and toileting, each rated on a 6-point scale; 2) social competency, including home, work, and recreational activities, each rated on 4-point scale, and 3) communication, rated on a 3-point scale. Scores range from 10-51 with higher scores indicating more dependency. The total scale reliability coefficient was 0.8 with cardiac patients and 1 month test-retest reliability was 0.62 (McCorkle R, Benoliel J. Cancer patient responses to psychosocial variables. Final report of project supported by grant #NU00730, Department of Health and Human Services. University of Washington; 1981). A Chronbach's alpha of 0.92 was reported along with a high correlation between the ESDS and the Sickness Impact Profile (Fink A. Social dependence and self-care agency: A descriptive-correlation study of ALS patients. Thesis. University of Washington; 1985).

Resource Utilization includes the numbers of unplanned rehospitalizations, acute care office or clinic visits, and ED use after the index hospital discharge visit.

### Data Collection of Case Studies

Case studies were developed from the patients' records and used to elicit experts' opinions on the need for referral. The medical records included progress notes, discharge plans, and discharge summaries. The research records contained previously recorded data obtained from interviews and the instruments described above. The cases sent to experts did not include the referral decisions made by hospital clinicians.

A data abstraction form was developed and organized using the 10 conditioning factors outlined by Orem's Self-Care Theory (Orem, D. E. Nursing: Concepts of practice, 3^{rd} ed. New York: McGraw-Hill; 1985:36). These included: age, gender, developmental state (mental status, function), health state (diagnosis, depression, medications, self-rated health), sociocultural factors (language spoken, patient values and preferences), health care system factors (prior hospitalization or home care use), family system factors (caregiver availability, ability, and willingness), patterns of living (substance use, habits, adherence), environmental factors (stairs in home, transportation), and socioeconomic factors (income, insurance).

The abstractors reviewed the medical records for assessments and interventions documented by the discharge planner, staff nurses, physicians, social workers, or physical therapists and included such information in the case study. The PI conducted weekly evaluation of the RAs' abstractions. An example of a case study is provided in Table 1.

TABLE 1
Sample Case Study

| | |
|---|---|
| Age, race, gender | 66 year old, African-American male |
| Health state | Patient was admitted emergently with fever, cough, sputum, increasing |
| | shortness of breath, bilateral rales and 3 plus leg edema. He was |
| | unresponsive to treatment at home and has a history of chronic obstructive |
| | pulmonary disease with a FEV1 of only 800 cc's. He was diagnosed with |
| | exacerbation of COPD, pneumonia, and congestive heart failure. Patient |
| | also has a history of gastritis. He experienced atypical chest pain with |
| | known coronary artery disease noted on cardiac catheterization in the past. |
| | He has recurrent supraventricular tachycardia and multifocal, atrial |
| | tachycardia. Upon admission the patient was placed on antibiotics and |
| | aggressive bronchodilator therapy including respiratory treatments. He was |
| | given intravenous Lasix and diuresed. At discharge, he was afebrile, with |
| | diffuse breath sounds but no further rales. Medications include, |
| | Augmentin, Verapril, Theodur, Aspirin, Atrovent inhaler, Beclovent, |
| | Ventolin, Tagamet, Ecotrin, Nitroglycerin, Lasix, K-dur and Prednisone. |
| | He spent 5 days in the hospital. |
| Developmental | Patient scored an 8/10 on the mental status questionnaire, and has a 5^{th}-8^{th} |
| state | grade education. He was unable to identify the current or previous |
| | president. Patient reports his own health as poor and reported his vision as |
| | good and his hearing as fair. Patient reports no difficulties taking his |
| | medications. He reports no special diet and a good appetite. Patient needs |
| | to rest while dressing and gets his shoes on by putting his foot up on the |
| | chair. He wears lose fitting clothing and manages to get dressed every day. |
| | Patient reports no restrictions with walking and takes frequent rests. He |
| | walks freely in his home. The patient feels limited with traveling and only |
| | travels by bus when necessary. Patient bathes himself every day and rests |
| | because it tires him out. Patient reports using a urinal on occasion, and |
| | reports occasional constipation and difficulty with beginning urination. He |
| | reports that his social interactions have decreased. Patient's friend does his |
| | shopping and most of his errands and yard maintenance. Patient feels |
| | limited because of health state. He has no contact with people outside his |
| | family and no longer keeps in touch with his friends. Patient currently |
| | receives meals on wheels and transportation assistance. Patient requested a |
| | shower stool. Patient scored a 23 on the depression scale. (16 or more = |
| | depression) |
| Health system | Patient was admitted emergently from the physician's office. He had just |
| factors | returned home for 5 days, after his last hospital admission for the same |
| | symptoms. The patient reports begin admitted and discharged once in the |
| | last 6 months and seeking care from his provider 3 times during that |
| | period. |
| Environmental | Patient lives in a single family home. The home has stairs and a bathroom |
| factors | on the bedroom level. There is no bathroom on the kitchen level. |
| Family system | Patient is widowed and lives with a friend. Patient's friend is his primary |
| factors | caregiver and he feels that he can call him whenever necessary. |
| Socioeconomic | Patient has Medicare Part A and B and no private health insurance |
| factors | supplement. He reported that his income is between $5,000 to 10,000 |
| | dollars/year. |

### Referral Decision Making

The case studies were posted on a secure web site in batches of 50. The 8 experts evaluated each case anonymously and independently and provided a yes/no recommendation about a referral. They were instructed to base their decision on clinical need and ignore potential barriers (e.g., homebound status or type of insurance). If a referral was recommended, the expert identified the reason and the desired follow-up service: home care, inpatient or outpatient rehabilitation, or nursing home. As could be expected, experts disagreed about recommendations to refer and/or the site. A second webpage was used to facilitate consensus on cases with discordant decisions. Using a modified Delphi technique, the experts saw the cases, the decisions reached by each expert, and reasons for or against referral. They were blinded to each other's identity, but able to compare their recommendation to others and were asked to consider the reasoning of the others and vote again trying to reach consensus; however they were not pressured to change their mind. The process of voting-feedback-voting was repeated up to 3 times until a majority consensus was obtained (Burns N, Grove SK. The Practice of Nursing Research: Conduct, critique, and utilization, 5^{th} edition. St Louis, Mo.: Elsevier Saunders; 2005). There were 12 cases without consensus after 3 rounds. Consensus was reached on all of them after in-person discussion.

### Data Analysis

Frequencies and cross tabulations compared the discharge referral rates of the experts to hospital clinicians. As an initial step in the analysis, the agreement between the hospital clinician and expert ratings was summarized. Two cases were inadvertently not sent to the experts for review. Three other cases were missing decisions from the hospital clinicians. Therefore, the final data set, having both hospital clinician and experts' decisions, decreased from 355 to 350. McNemar's test (Munro, B H Statistical Methods for Health Care Research, 5^{th} edition, Philadelphia: Lippincott William's & Wilkins; 2005:122-123) compared the referral rates of the experts versus the hospital clinicians. A new variable (refergp) was created to compare the differences between the groups (refergrp=No/No, Yes/No, and Yes/Yes). Next, bivariate comparison with refergp were conducted using oneway ANOVA (if variable was normally distributed), Kruskal-Walis test (non-normal continuous distribution), chi-square test (categorical variable) and odds ratios as appropriate (Hosmer D W, Lemeshow S. Applied Logistic Regression. New York, N.Y.: John Wiley & Sons, Inc.; 1989). Additionally, if the 3 groups were significantly different, pairwise tests using appropriate adjustments for multiple comparisons were conducted to determine the significantly different groups. Given that the referral decisions were based on patient baseline characteristics, no adjustments were made for these differences in the 12 week outcome analysis, because that would erase the basis of the experts' and hospital clinicians' decisions. Instead, the decision groups were considered as clusters of patients derived from their baseline characteristics.

### Example 1 Results

The experts recommended referrals for 282 (81%) of the cases and did not recommend referrals for 68 (19%). Hospital clinicians recommended 101 referrals (29%) and did not recommend referrals for the remaining 249 cases (71%). Sample characteristics are shown in Table 2.

TABLE 2
Experts' and hospital clinicians' decisions to refer or not.

| | Hospital Referral Decisions | | |
|---|---|---|---|
| Expert Referral Decisions | Do Not Refer (No) | Refer (Yes) | Total |
| Do Not Refer (No) | 66 | 2 | 68 |
| Refer (Yes) | 183 | 99 | 282 |
| Total | 249 | 101 | 350 |

*sample decreased to 350 from 355 because 2 cases were accidentally not sent to the experts and the hospital clinician decision was missing on 3 others.

Agreement in decisions between experts and hospital clinicians occurred for 165 cases (47%, 66 Do Not Refer+99 Refer). The experts were 18 times more likely to refer patients for post discharge services than hospital clinicians (OR=17.8, 95% CI=4.3-74.4, p<0.001). Although there was great disparity in the referral decisions, patients referred by both experts and clinicians (Yes/Yes) varied on only a few characteristics from those referred by expert only (Yes/No).

Hospital clinicians were more likely to refer patients who were older (mean age 76.2 versus 74, p <0.001), had surgery (OR=1.9, 95% CI=1.1-3.2, p=0.025), had a longer length of stay (mean 9.3 versus 6.8 days p. <0.001), or who had lower rates of help being available whenever needed (56.6% versus 81.6%, p<0.001) than patients referred by experts only (See Table 3). They were also more likely to report fair or poor health, needing and using more resources including home care nursing, and had worse bathing and work role function than the expert only referral group.

TABLE 3
Sociodemographic and health characteristics of sample, overall, by expert/hospital decisions.

| | | | Expert/Hospital Decisions | | | | | | |
|---|---|---|---|---|---|---|---|---|---|
| Variable | All | | No/No | | Yes/No | | Yes/Yes | | |
| mean ± st. dev or freq (%) | n = 348 ² | | n = 66 | | n = 183 | | n = 99 | | p-value ¹ |
| Age | 74.3 ± 5.7 | | 72.4 ± 5.0 ^{c} | | 74.0 ± 5.7 ^{c} | | 76.2 ± 5.7 ^{a b} | | <.001 |
| Female | 188 | (54.0%) | 27 | (40.9%) | 105 | (54.7%) | 56 | (56.6%) | 0.059 |
| Race ² | | | ^{b c} | | ^{a} | | ^{a} | | 0.007 |
| White | 256 | (73.6%) | 57 | (86.4%) | 132 | (72.1%) | 67 | (67.7%) | |
| Black | 90 | (25.9%) | 7 | (10.6%) | 51 | (27.9%) | 32 | (32.3%) | |
| Asian or Pacific Islands | 2 | (0.6%) | 2 | (3.0%) | 0 | (0.0%) | 0 | (0.0%) | |
| Income level <20K (INCOMELV) | 149 | (42.8%) | 13 | (19.7%) ^{b c} | 89 | (48.6%) ^{a} | 47 | (41.5%) ^{a} | <.001 |
| Education (DMEDUC1) | | | ^{b c} | | ^{a} | | ^{a} | | 0.008 |
| Less than High School | 104 | (30.0%) | 7 | (10.6%) | 61 | (33.3%) | 36 | (36.7%) | |
| Completed High School | 115 | (33.1%) | 27 | (40.9%) | 56 | (30.6%) | 32 | (32.7%) | |
| Some college/trade school | 60 | (17.3%) | 12 | (18.2%) | 34 | (18.6%) | 14 | (14.3%) | |
| College graduate | 68 | (19.6%) | 20 | (30.3%) | 32 | (27.5%) | 16 | (16.3%) | |
| Total resources needed | 0.5 ± 1.0 | | 0.1 ± 0.3 ^{b c} | | 0.5 ± 1.0 ^{a c} | | 0.9 ± 1.2 ^{a b} | | <.001 |
| Resource Use: Used Nursing | 27 | (7.8%) | 4 | (6.1%) | 9 | (4.9%) ^{c} | 14 | (14.1%) ^{b} | 0.019 |
| Care Prior to Admission | | | | | | | | | |
| Total resources used [0-5] | 0.4 ± 0.9 | | 0.2 ± 0.6 ^{c} | | 0.3 ± 0.7 ^{c} | | 0.7 ± 1.1 ^{a b} | | 0.007 |
| Eating function | | | ^{b c} | | ^{a} | | ^{a} | | <.001 |
| No restriction | 112 | (32.2%) | 33 | (50.0%) | 47 | (25.7%) | 32 | (32.3%) | |
| Minor restriction | 176 | (50.6%) | 31 | (47.0%) | 104 | (56.85) | 41 | (41.4%) | |
| Occasional/Daily help | 60 | (17.2%) | 2 | (3.0%) | 32 | (17.5%) | 26 | (26.3%) | |
| Walking function | | | ^{b c} | | ^{a} | | ^{a} | | <.001 |
| No restriction | 102 | (29.3%) | 41 | (62.1%) | 41 | (22.4%) | 20 | (20.3%) | |
| Minor restriction | 115 | (33.1%) | 21 | (31.8%) | 64 | (35.0%) | 30 | (30.3%) | |
| Major restriction | 131 | (37.6%) | 4 | (6.1%) | 78 | (42.6%) | 49 | (49.5%) | |
| Dressing function | | | ^{b c} | | ^{a} | | ^{a} | | 0.001 |
| No restrictions | 205 | (58.9%) | 51 | (77.3%) | 106 | (57.9%) | 48 | (48.5%) | |
| Restrictions | 143 | (41.1%) | 15 | (22.7%) | 77 | (42.1%) | 51 | (51.5%) | |
| Bathing function | | | ^{b c} | | ^{a c} | | ^{a b} | | <.001 |
| No restriction | 214 | (61.5%) | 59 | (89.4%) | 110 | (60.1%) | 45 | (45.5%) | |
| Minor restriction | 49 | (14.1%) | 6 | (9.1%) | 31 | (16.9%) | 12 | (12.1%) | |
| Equipment/Daily help | 85 | (24.4%) | 1 | (1.5%) | 42 | (23.0%) | 42 | (42.4%) | |
| Toileting function | | | ^{b c} | | ^{a} | | ^{a} | | <.001 |
| No restriction | 164 | (47.1%) | 52 | (78.8%) | 80 | (43.7%) | 32 | (32.3%) | |
| Minor restriction | 116 | (33.3%) | 12 | (18.2%) | 68 | (37.2%) | 36 | (36.4%) | |
| Equipment use/Incontinent | 68 | (19.5%) | 2 | (3.0%) | 35 | (19.1%) | 31 | (31.3%) | |
| Travel function | | | ^{b c} | | ^{a} | | ^{a} | | <.001 |
| No restriction | 184 | (52.9%) | 56 | (84.9%) | 83 | (45.4%) | 45 | (45.5%) | |
| Minor restriction | 52 | (14.9%) | 7 | (10.6%) | 29 | (15.9%) | 16 | (16.2%) | |
| Travels freely with help | 40 | (11.5%) | 3 | (4.6%) | 26 | (14.2%) | 11 | (11.1%) | |
| Major restrictions | 37 | (10.6%) | 0 | (0.0%) | 25 | (13.7%) | 12 | (12.1%) | |
| Homebound | 35 | (10.1%) | 0 | (0.0%) | 20 | (10.9%) | 15 | (15.2%) | |
| Activities in home function | | | ^{b c} | | ^{a} | | ^{a} | | <.001 |
| Usual activity | 147 | (42.2%) | 51 | (77.3%) | 67 | (36.6%) | 29 | (29.3%) | |
| Modified activity | 108 | (31.0%) | 14 | (21.2%) | 64 | (35.0%) | 30 | (30.3%) | |
| Restricted/no activity | 93 | (26.7%) | 1 | (1.5%) | 52 | (28.4%) | 40 | (40.4%) | |
| Work role function | | | ^{b c} | | ^{a c} | | ^{a b} | | <.001 |
| Usual activity | 160 | (46.0%) | 53 | (80.3%) | 80 | (43.7%) | 27 | (27.3%) | |
| Modified activity | 81 | (23.3%) | 7 | (10.6%) | 47 | (25.7%) | 27 | (27.3%) | |
| Restricted activity | 71 | (20.4%) | 2 | (3.0%) | 39 | (21.3%) | 30 | (30.3%) | |
| No activity | 36 | (10.3%) | 4 | (6.1%) | 17 | (9.3%) | 15 | (15.2%) | |
| Recreational Activities function | | | ^{b c} | | ^{a} | | ^{a} | | <.001 |
| Usual activity | 197 | (56.6%) | 56 | (84.9%) | 91 | (49.7%) | 50 | (50.5%) | |
| Modified activity | 81 | (23.3%) | 10 | (15.2%) | 49 | (26.8%) | 22 | (22.2%) | |
| Restricted/no activity | 70 | (20.1%) | 0 | (0.0%) | 43 | (23.5%) | 27 | (27.3%) | |
| Total function score [10-51] | 18.4 ± 7.7 | | 12.4 ± 2.7 ^{b c} | | 19.1 ± 7.3 ^{a} | | 21.2 ± 8.7 ^{a} | | <.001 |
| Total # of Conditions | 4.7 ± 2.3 | | 3.6 ± 2.0 ^{b c} | | 5.0 ± 2.3 ^{a} | | 4.9 ± 2.2 ^{a} | | <.001 |
| Depression score admission | 11.5 ± 10.7 | | 6.7 ± 5.9 ^{b c} | | 12.8 ± 10.7 ^{a} | | 12.8 ± 12.4 ^{a} | | 0.001 |
| [0-60] | | | | | | | | | |
| Imputed Depression score | 12.2 ± 9.6 | | 7.2 ± 5.5 ^{b c} | | 13.2 ± 9.3 ^{a} | | 13.6 ± 11.1 ^{a} | | <.001 |
| admission [0-60] | | | | | | | | | |
| Surgery occurred during | 104 | (29.9%) | 16 | (24.2%) ^{c} | 48 | (26.2%) ^{c} | 40 | (40.4%) ^{a b} | 0.025 |
| admission | | | | | | | | | |
| Complicated hospital stay | 56 | (16.1%) | 5 | (6.1%) ^{c} | 31 | (16.9%) | 21 | (21.2%) ^{a} | 0.031 |
| Length of Index Stay | 7.1 ± 6.1 | | 4.6 ± 3.4 ^{b c} | | 6.8 ± 5.7 ^{a c} | | 9.3 ± 7.4 ^{a b} | | <.001 |
| Help is available | 318 | (91.4%) | 65 | (98.5%) ^{c} | 168 | (91.8%) | 85 | (85.7%) ^{a} | 0.017 |
| Help available whenever needed | 247 | (70.1%) | 60 | (90.9%) ^{b c} | 131 | (81.6%) ^{a c} | 56 | (56.6%) ^{a b} | <.001 |
| Subjective health rating | | | ^{b c} | | ^{a c} | | ^{a b} | | <.001 |
| Excellent | 42 | (12.1) | 23 | (34.9%) | 10 | (5.5%) | 9 | (9.1%) | |
| Good | 126 | (36.2%) | 24 | (36.4%) | 79 | (43.2%) | 23 | (23.2%) | |
| Fair/poor | 180 | (51.7%) | 19 | (28.8%) | 94 | (51.4%) | 67 | (67.7%) | |

| | | | | | |
|---|---|---|---|---|---|
| Number of prescription | 5.7 ± 3.3 | 5.2 ± 3.6 | 5.9 ± 3.2 | 5.8 ± 3.2 | 0.246 |
| medications on discharge | | | | | |
| SPMSQ score on admission | 9.6 ± 0.8 | 9.8 ± 0.4 ^{b c} | 9.5 ± 0.8 ^{a} | 9.4 ± 0.8 ^{a} | 0.009 |
| {0-10} | | | | | |
| Quality of life on admission | 6.4 ± 2.8 | 8.0 ± 2.1 ^{b c} | 6.0 ± 2.7 ^{a} | 5.6 ± 3.0 ^{a} | <.001 |
| [0-10] | | | | | |
| Number of health care visits | 6.2 ± 7.3 | 5.1 ± 6.0 | 6.7 ± 7.0 | 6.1 ± 8.6 | 0.111 |
| (past 6 months) | | | | | |
| Number of hospital admissions | 0.8 ± 1.1 | 0.5 ± 0.7 ^{b c} | 0.9 ± 1.2 ^{a} | 1.0 ± 1.1 ^{a} | 0.003 |
| (past 6 months) | | | | | |

¹ Test of any differences between the 3 decision groups.
² Two subjects listed as Asian or Pacific Islander excluded from statistical analysis.
^{a} Significantly different from no/no group
^{b} Significantly different from yes/no group
^{c} Significantly different from yes/yes group

Ideally, the outcomes of the expert referral and no-referral would be compared separately for those who did and did not receive an actual referral. However, of the 101 who received an actual referral, there were only 2 that received a rating of no-referral from the expert-only panel (second column of Table 2). Thus, the analysis compared the 12 week outcomes of the expert-only referral group (Yes/No), to those that experts and clinicians agreed on (Yes/Yes and No/No).

Table 4 summarizes the differences between resource utilization outcomes at 12 weeks for the expert-only referral and the other referral groups.

TABLE 4
Twelve week resource utilization, health rating, and functional outcomes, overall and by expert/hospital decision.

| | | | Expert/Hospital Decisions | | | | | | |
|---|---|---|---|---|---|---|---|---|---|
| Variable | All | | No/No | | Yes/No | | Yes/Yes | | |
| mean ± st. dev or freq (%) | n = 348 ² | | n = 66 | | n = 183 | | n = 99 | | p-value ¹ |
| Rehospitalized up to 12 weeks | 67 | (19.3%) | 4 | (6.2%) ^{b c} | 43 | (23.5%) ^{a} | 20 | (20.2%) ^{a} | 0.009 |
| Acute MD visits post dc to 12 weeks | 0.9 ± 1.8 | | 0.5 ± 1.1 | | 0.9 ± 1.6 | | 1.1 ± 2.3 | | 0.083 |
| Used ER between DC and 12 weeks | 43 | (12.4%) | 5 | (7.7%) | 26 | (14.2%) | 12 | (12.2%) | 0.392 |
| Subjective health rating at 12 weeks | | | ^{b c} | | ^{a} | | ^{a} | | 0.002 |
| Excellent | 42 | (14.0%) | 15 | (25.9%) | 19 | (12.0%) | 8 | (9.5%) | |
| Good | 155 | (51.7%) | 35 | (60.3%) | 77 | (48.7%) | 42 | (51.2%) | |
| Fair/poor | 103 | (34.3%) | 8 | (13.8%) | 62 | (39.2%) | 33 | (39.3%) | |

| | | | | | |
|---|---|---|---|---|---|
| Total Function Score at 12 weeks | 18.0 ± 8.0 | 12.3 ± 3.0 ^{b c} | 18.2 ± 7.3 ^{a c} | 21.5 ± 9.3 ^{a b} | <.001 |

¹ Test of any differences between the 3 decision groups.
² Two subjects listed as Asian or Pacific Islander excluded from statistical analysis.
^{a} Significantly different from no/no group
^{b} Significantly different from yes/no group
^{c} Significantly different from yes/yes group

Subjects in the expert-only referral group (Yes/No) demonstrated nearly a five-fold risk of a subsequent rehospitalization during the 12 week follow-up compared to the no referral group (No/No), (OR=4.7, 95% CI=1.6-13.6, p<0.009). Nearly 24% of the expert-only (Yes/No) referral group experienced a rehospitalization compared to 6.2% of the no referral group, and 20.2% of those who did get post discharge services. Those who did get services (Yes/Yes) were also significantly more likely to be rehospitalized than those experts and clinicians agreed not to refer (OR=3.9, 95% CI=1.3-11.9, p=0.009), but were not statistically more or less likely to be rehospitalized than the Yes/No group who did not get post discharge services (23.5% versus 20.2%).

Patients in the expert-only referral group had more acute MD visits during the 12 week period than the no referral group, but this was not statistically significant (0.9 versus 0.5, p=0.083). Similar results were found when compared to patients who did get a referral (0.9 to 1.1, p=0.83). In addition, 14.2% of the patients in the Yes/No group used the ED during that same time period compared to 12.2% or 7.7% for the Yes/Yes and No/No groups respectively, although these differences were not statistically significant (p=0.392).

Table 4 also summarizes the self-rated health and functional status outcomes. For self-rated health status, the Yes/Yes and Yes/No groups rated their health worse than the No/No group (p=0.001). For total function score, all 3 groups were found to be significantly different from each other. The Yes/Yes group (mean=21.5, SD=3.0) had worse functional status than the Yes/No group (mean=18.2, SD=7.3) (p=0.011) and the No/No group (mean=12.3, SD=3.0) (p<0.001).

This study reveals major gaps in quality regarding discharge decision making and the costly consequences of those gaps. Experts who reviewed case studies of discharged hospital patients recommended post discharge care for 183 patients who in real life did not receive referrals from hospital clinicians. The experts succeeded in identifying patients who 12 weeks later had poorer outcomes including more ED and doctor office use, significantly higher rates of rehospitalizations, and lower self-rated health and function. Patients recommended for referrals by experts, but who did not receive them, were 5 times more likely to undergo a rehospitalization than those identified as not needing a referral, suggesting the need for improved identification of patients in need of services.

The experts identified a cohort of patients who, although they had significantly worse health characteristics at baseline than patients not referred for post discharge services, also did not get referred. They had higher scores (worse) on all aspects of function. They reported needing more resources, having a higher incidence of fair/poor rated health and prior hospital use, lower quality of life scores, less education, more co-morbid conditions, higher (worse) depression scores, longer length of stay, and lower mental status scores.

The patients who did get referred by hospital clinicians had a few characteristics that were significantly different from the expert only referral group. However, these characteristics tend to be quite obvious ones. For example, hospital clinicians referred patients who were older, had surgery, had a longer length of stay, reported not having help available, used a larger number of resources and post discharge services in the past, had deficits in bathing function, and fewer were employed. Study findings reinforce that the availability of higher quality information in the case studies contributed to differences between experts and clinicians in identifying patients at risk. For example, experts may have recommended patients for referrals based on information not routinely assessed and documented during hospitalizations including depression, mental status, and quality of life. For the hospital clinicians, information was interspersed throughout the medical record, if documented at all. For the experts it was presented in a summary, case study format. The experts also were free of time pressures while making their decisions and were told to base their decisions on patient need not on insurance regulations. Therefore, study findings suggest that with higher quality information and freedom to exercise their judgment, clinicians do better in recognizing the needs of elders who have unmet needs at discharge.

Patients recommended by the experts who did not receive referrals had lower self-rated health and worse function at 12 weeks than those clinicians and experts agreed not to refer. Although not as functionally impaired by 12 weeks as those who did get a referral, their mean functional status score remained impaired thus increasing their risk for rehospitalization. Wilber, Blanda, and Gerson (Wilber et al., 2006, Acad Emerg Med 13:680-682) demonstrated that 65% and 75% of patients used the ED because of a decline in instrumental and physical activities of daily living, respectively. For 88% of this latter group, decreased ability to dress, transfer, and walk resulted in ED use, indicating the importance of providing post discharge services to prevent decline.

These findings suggest that many more patients may have needed or benefited from a post discharge referral than received it. But, there are several barriers that impede older adults from receiving the care they need. These include a lack of time, skill, procedures, and patient assessment information that support accurate discharge referral decision making (Bowles et al., 2002, J Am Geriatr Soc 50:336-342; Potthoff S J, Kane R L, Franco S J. Hospital Discharge Planning for elderly patients: Improving Decisions, aligning incentives. 1985 (Master Contract 500-92-0048); Bowles et al., 2003, Appl Nurs Res. 16:134-43). Baker and Wellman (Baker et al., 2005, J Amer Diet Assoc 105:603-607) found, in 11 hospitals, that 98% of case managers responsible for discharge planning reported excessive patient loads and responsibilities as job barriers. Experts had more time and a less stressful environment in which to make their decisions compared to the time and environment afforded to hospital clinicians (Prescott et al., 1995, Res Nurs Health 18:85-95; Potthoff S J, Kane R L, Franco S J. Hospital Discharge Planning for elderly patients: Improving Decisions, aligning incentives. 1985 (Master Contract 500-92-0048)). Furthermore, the experts were instructed to make their referral decisions based on need without regard for reimbursement or Medicare eligibility criteria such as being homebound.

These findings were also influenced by the use of a multidisciplinary team of experts. Multiple studies demonstrate that interdisciplinary management of older adults' complex needs results in improved health care processes and patient outcomes (Geriatrics Interdisciplinary Advisory Group. 2006, J Amer Geriatr Soc. 54:849-852). A team more accurately identifies factors that place patients at risk for poor outcomes. The model of discharge planning used by the hospital clinicians did not always include an interdisciplinary team but rather relied upon individual nurse, social worker, or physician input with varying levels of risk tolerance, assessment and decision making skill, and knowledge of the benefits of post discharge care.

### Example 2

### Development of Six-Factor Model

Example 2 addressed two specific aims: to elicit expert knowledge about factors important to referral decision making and, and to identify the characteristics of hospitalized patients who need a post-acute referral.

### Example 2 Methods

A mixed method, comparative and exploratory analysis of the characteristics of hospitalized older adults and the decisions of experts to refer them for post-acute care was conducted on a combined retrospective and prospective sample. The independent variables were derived through various methods of knowledge elicitation including case study analysis, Delphi rounds, focus groups, and data mining. Details of these methodologies are described below. The dependent variable was the experts' yes/no referral decision.

Orem's Self-Care Deficit Theory guided the identification and organization of factors that affect the patient's ability to care for his/her self Nursing care is appropriate when the person is not able to engage in self-care (Orem, D. E. (1985). Nursing: Concepts of practice (3^{rd} ed.). New York: McGraw-Hill). Orem notes that basic conditioning factors are internal or external factors that affect the ability of an individual to engage in self-care or influence the amount of self-care required. These basic conditioning factors fall into 10 categories: age; gender; developmental state; health state; sociocultural orientation; health care system factors; family systems factors; patterns of living; environmental factors; and, socioeconomic factors (Orem, D. E. (1985). Nursing: Concepts of practice (3^{rd} ed.). New York: McGraw-Hill). The Orem conditioning factors provided the framework to categorize information abstracted from patients' records, and to organize the ontology and the discussion during expert focus groups.

### Study Sample

The sample contained 355 older adults admitted to one of six hospitals (urban, suburban, and rural). Data came from two sources: existing records and a convenience sample. The original plan was to analyze only existing records but the experts requested additional cases to add variety to types of diagnoses represented. The data sets were combined because they contained measures of the same variables and the analysis achieved the same goal for both datasets. Their retrospective or prospective nature did not affect the study design.

### Existing Records

The existing records were taken from among the control group patients enrolled during three completed randomized clinical trials (Naylor, et al., 1994, Annals of Internal Medicine, 120:999-1006; Naylor, et al., 1999, Journal of the American Medical Association, 281:613-620; Naylor, et al., 2004, Journal of the American Geriatric Society, 52:675-84). These records were used because they had a comprehensive database of variables that described the characteristics of older adults while hospitalized and 12 weeks after discharge. The same variables were collected across all three studies and the control group was used so that the effects of the RCT intervention did not influence the 12 week outcomes. A list of subject IDs (N=443) was generated from the control groups of the three completed studies. A power analysis, using the standard error of 0.045 associated with the area under the curve (AUC) statistic and assuming an anticipated concordance of 0.80, calculated the minimum number of cases to be 100 (50 referral+50 non-referral) (Hanley & McNeil, 1982, Radiology, 143:29-36). However, based on pilot work, where the majority of patients were referred by experts, a larger sample was drawn to assure enough non-referral types. Therefore, 245 subjects were chosen randomly using a table of random numbers. After reviewing these records, 37 were not used because of missing data (N=21); withdrawal or moved (N=6); not readable (N=3); cases too similar N=2) or cases used to train the abstractors (N=5). The remaining 208 records were used in this study. Data on the remaining 147 older adults were collected prospectively from a convenience sample enrolled from an academic medical center (N=50) and a rural, community hospital (N=97), both sites used in the previous studies.

All subjects were age 65 and older, English speaking, cognitively intact, and expected to be discharged home. In addition, patients enrolled in Studies two and three met at least one criteria associated with risk for poor discharge outcomes (Naylor, et al., 1999, Journal of the American Medical Association, 281:613-620; Naylor, et al., 2004, Journal of the American Geriatric Society, 52:675-84). Subjects in Study one were admitted for heart failure, angina pectoris, myocardial infarction, valve replacement or coronary artery bypass surgery (Naylor, et al., 1994, Annals of Internal Medicine, 120:999-1006). Study two patients had those diagnoses and respiratory infection, major small and large bowel surgery, or lower extremity orthopedic surgery (Naylor, et al., 1999, Journal of the American Medical Association, 281:613-620). Study three patients were all admitted for heart failure (Naylor, et al., 2004, Journal of the American Geriatric Society, 52:675-84).

Subjects enrolled prospectively met the same inclusion criteria except for diagnoses and the criteria associated with poor outcomes. They were sought because the experts requested cases with more diversity in diagnosis and severity. These cases represented cancer, diabetes, infection, genitourinary conditions, and traumatic injury and were mixed with the others before presentation to the experts. All patients had the same database of information about their characteristics available for analysis (ie. function, number of conditions, caregiver availability).

### Data Collection

Case studies were developed from the patients' medical records and interviews conducted during the index hospitalization. Data was collected on age, race, gender, income, education, living arrangement, insurance, medical diagnosis, co-morbidities, adverse events, admission and discharge medications, length of stay (LOS), previous home care or hospitalization in last 6 months, use of assistive devices or services, and patient's perceived need for devices or services after discharge. Measures of self-rated health, cognition, functional status, and depression were obtained using standardized instruments. Discharge disposition was recorded to know whether the patient received a referral for post-acute services or not and subsequent rehospitalization and Emergency Department use was up to 12 weeks post-acute care discharge. All post-acute services were verified by subsequent medical record review. Trained nursing graduate student research assistants collected all data in-person during hospitalization and by telephone at 12 weeks.

### Instruments

Self-rated health status is the patient's perception of overall health measured using a single question, “How would you rate your overall health at the present time? Is it excellent, good, fair, or poor?” (Maddox et al., 1973, Journal of Health and Social Behavior 14:87-93).

The Short Portable Mental Status Questionnaire (SPMSQ) was used to measure the presence and degree of intellectual impairment. It is a valid and reliable measure of mental status in the elderly (Roccaforte, Burke, Bayer, & Wengel, 1994). For construct validity the SMPSQ showed good correlation with the Mini Mental State Exam and a test-retest reliability k value of 0.45 was reported with a sensitivity of 0.74 and specificity of 0.91 for detecting dementia (Roccaforte, et al., 1994, Journal of Geriatric Psychiatry and Neurology, 7:33-38). Functional Status was measured using the Enforced Social Dependency Scale (Moinpour, C., McCorkle, R., & Saunders, J. (1981). Measuring functional status. In M. Frank-Stromborg (Ed.), Instruments for clinical nursing research (pp. 385-401). Boston, Mass.: Jones and Bartlett). Enforced social dependency is defined as needing assistance to perform activities or roles that adults can usually do alone. The instrument describes patient's function regarding eating, dressing, walking, traveling, bathing, toileting; home, work, and recreational activities; and communication. Scores range from 10-51 with higher scores indicating more dependency. McCorkle and Benoliel (McCorkle, R., & Benoliel, J. (1981). Cancer patient responses to psychosocial variables. Final report of project supported by grant #NU00730, DHHS. University of Washington) reported a 0.8 reliability coefficient for the total scale with cardiac patients and a test-retest reliability for the revised scale was 0.62.

Depression was measured using the Centers for Epidemiologic Studies Depression Scale (CES-D) (Radloff, 1977, Applied Psychological Measurement 1:385-401). Depression was not measured in Study one and partially in Study three patients. Subjects rate the occurrence of 20 items during the last week, scores ≧16 indicate depressive symptoms. The scale has high internal consistency (0.85) and adequate test-retest reliability (average of 0.53 for different samples, including the elderly) (Callahan, et al, 1994, Journal of the American Geriatrics Society, 42(8):833-838). Subsequently, depression scores were collected on 100 patients using CES-D as well as the two item depression questions as described herein. Adequate correlation was achieved, thus allowing for the substitution of the shorter depression questions as described herein.

### Development of Case Studies

The principal investigator used five records to train two RAs in abstracting information from the research and medical records of each patient. The abstractors read the entire case to become familiar with the content and context. During a second reading, information about the assessments and interventions documented in the progress notes, discharge plans and summaries was collected and summarized into a case study as shown in Table 5. The 10 Orem basic conditioning factors provided the organizing framework to standardize the format of the case studies. The PI reviewed all 355 cases for completeness, grammatical, and medical accuracy before they were sent to the experts.

TABLE 5
An Example of a Case Study Sent to the Experts

| | |
|---|---|
| Age/Gender/Race | The patient is a 78 year-old, white, male. |
| Health State | The patient was admitted for shortness of breath, coughing, and |
| | chest tightness. A chest x-ray was performed and his diagnosis was |
| | pneumonia and exacerbation of COPD. He was admitted and treated |
| | with IV antibiotics and nebulizer treatments. Past medical history is |
| | significant for coronary artery disease, atrial fibrillation, COPD, |
| | hypercholesterolemia, and diabetes mellitus secondary to steroid |
| | use. Medications prior to this admission include Aspirin, Cartia, |
| | Combivent, Coumadin, Digoxin, Flovent, Nitrostat, and Augmentin |
| | (for the last 2 days). Discharge medications included Levaquin and |
| | Glucotrol. Length of stay was 3 days. |
| Developmental State | The patient attended school until the 10^{th} grade. He is retired. He |
| | scored 9/10 on the mental status exam and 9 on the depression scale |
| | (16-60 = depression). He is independent in all activities of daily |
| | living. He has no health aids and does not feel that he needs any. He |
| | has no dietary restrictions. He reports fatigue and shortness of breath |
| | while dressing, walking, and bathing. He rated his health as fair at |
| | the present time. He has not used any formal health services and |
| | does not feel he needs any. |
| Health Care System | The patient has had no hospitalizations in the past six months. He |
| Factors | saw his doctor twice in the past six months. |
| Family System Factors | The patient is married and lives with his spouse. He considers his |
| | wife and son to be his primary caregivers. They are available |
| | whenever needed. |
| Environmental Factors, | The patient lives in a single-family home. There is a bathroom on |
| patterns of living | the level of the bedroom and kitchen. |
| Socioeconomic Factors | The patient reports his income as $5,000-10,000/year and is insured |
| | by Medicare Parts A and B and private health insurance. |

### Experts

Four nationally recognized scholars and four local clinicians were selected as experts. The four national scholars were chosen based on their published record of scholarly work in discharge planning and the care of the elderly. They held either a PhD or MD degree. The four clinical experts were recommended by their acute care managers for their discharge planning skill and had at least five years experience in discharge decision making for older adults. They held at least a MS or MD degree. This multidisciplinary group contained two of each of the major disciplines involved in discharge planning: physicians, nurses, social workers, and physical therapists. They were paid $55.00/hour and each case took 15-30 minutes to review.

### Expert Judgments and Data Management

The cases were posted online where the experts anonymously and independently evaluated each case and provided a yes or no referral decision, identified which patient characteristics (factors) influenced their decision, and if a referral was suggested, to which post-acute service. Their findings (recorded on the website) were automatically entered into a relational database for analysis. Cases were posted for the experts in batches of 50. When all eight experts entered their judgments, the round was considered complete. All cases for which there was not agreement for the yes/no referral decision and the site were posted for Delphi rounds. Three Delphi rounds enabled the experts to review the case again and judge again. The goal was to seek consensus. The experts could see each other's decisions and reasons, but not their identity. In this subsequent review the experts considered the various viewpoints of their colleagues and, if they changed their mind, indicated their new decision and the reasons for it. After three rounds, if total agreement was not reached, the majority decision (reflected by at least five experts) was accepted. This occurred for 91 of the cases (26%). There were 12 cases with a tie (four said yes, four said no) that were discussed in the final in-person session and resolved. The experts achieved statistically significant correlations among their decisions regardless of discipline (r=0.291-0.517, p=0.01).

An ontology was developed in collaboration with the experts to standardize the reasons for referral. An ontology is a formal representation of a set of concepts within their domains, and the relationships between those concepts. It is used to define the domain. By systematically coding each of the factors, the terms used by the experts were standardized to describe the reasons for referral or not and prepare the qualitative data for more robust analyses. For example, one expert might have said refer because the patient has difficulty walking, another might have said refer because of impaired mobility. These two terms were each coded with the same code within the ontology so they could be categorized and counted. The study investigators created the ontology using the domain headings from the Orem Self Care Deficit theory and created subcategories under them that described the terms used by the experts. Techniques used are further described by Castro (Castro, et al., 2006, Bioinformatics, 7:267). For example the Orem category of Developmental State contained ontology code 1.0 functional status with subcategories of 1.1 walking ability, 1.2 bathing ability, etc. were subcategories within that domain. Prior to coding the reasons for referral, the study team presented the ontology categories to the experts for approval. The experts and study investigators coded several cases together and the experts affirmed that the ontology domains and subcodes adequately captured their meaning. The PI was the primary coder, with member checks by the experts on every 50th case and inter-rater reliability of 92% was achieved with a co-investigator MDN on a random sample of 10% of the codes. When coders did not agree or were unclear they were discussed with the experts. These data were analyzed using data mining techniques, recursive partitioning, and decision tree algorithms (Witten, I., & Frank, E. (2005). Data mining: Practical machine learning tools and techniques (2^{nd} ed.). San Francisco, Calif.: Morgan Kaufmann). These exploratory analyses helped to identify the most common factors related to the decisions. The results were discussed in the focus groups described below.

### Focus Groups

Over the course of the study, seven in-person sessions were held with the local experts, and national experts participated by e-mail, telephone, and one in-person session. During these sessions the ontology was validated, cases reviewed, and the factors identified by the data mining were discussed. The eight experts reviewed the rules generated by the data mining and systematically considered each factor in relation to the decision to refer or not. Factors identified by the experts as important were included in the logistic regression analyses (Table 6).

TABLE 6
Variables Considered in the Logistic Regression

| | | Frequency | | |
|---|---|---|---|---|
| Variable | | (%) | | Mean ± SD |
| Function: bathing | No restriction | 219 | (61.7) | |
| | Minor restriction | 49 | (13.8) | |
| | Help of | 55 | (15.5) | |
| | equipment | | | |
| | Daily person | 32 | (9.0) | |
| | assist | | | |
| Function: eating | No restriction | 117 | (33.0) | |
| | Minor restriction | 178 | (50.1) | |
| | Occasional help | 20 | (5.6) | |
| | Daily assistance | 40 | (11.3) | |
| Function: walking | No restriction | 106 | (29.9) | |
| | Minor restriction | 117 | (33.0) | |
| | Major restriction | 132 | (37.2) | |
| Function: dressing | No restriction | 209 | (58.9) | |
| | Restrictions | 146 | (41.1) | |
| Mental Status | Normal mental | 343 | (96.6) | 9.56 ± .769 |
| | status | | | |
| | Cognitively | 12 | (3.4) | |
| | impaired | | | |
| Who lives with | Spouse | 175 | (49.3) | |
| patient | Other person | 81 | (22.8) | |
| | No one | 98 | (27.6) | |
| Subjective health | Excellent | 44 | (12.4) | |
| | Good | 128 | (36.1) | |
| rating | Fair/poor | 183 | (51.5) | |
| Rehospitalization in | None | 166 | (46.8) | |
| past 6 months | 1 prior hosp | 122 | (34.4) | |
| | 2 or more prior | 62 | (17.5) | |
| | hosp | | | |
| Length of Stay | | 355 | | 7.08 ± 6.05 |
| (days) | | | | |
| Complicated hospital | No | 297 | (83.7) | |
| stay | Yes | 58 | (16.3) | |
| Surgery occurred | No | 249 | (70.1) | |
| during admission | Yes | 106 | (29.9) | |
| Patient is at risk | No | 343 | (96.6) | |
| for falls | Yes | 12 | (3.4) | |
| Help available | No help/don't | 30 | (8.5) | |
| | know | | | |
| | Yes | 325 | (91.5) | |
| How often is help | None or | 102 | (28.7) | |
| available | intermittent | | | |
| | When ever | 253 | (71.3) | |
| | needed | | | |
| Patient perspective | No resources | 252 | (71.0) | |
| on total number of | needed | | | |
| resources needed | 1+ resources | 101 | (28.5) | |
| | needed | | | |
| Age (years) | | 354 | | 74.25 ± 5.7 |
| Income level | >=20K | 203 | (57.2) | |
| | <20K | 152 | (42.8) | |

| | | |
|---|---|---|
| Total Number of Co- | 354 | 4.71 ± 2.3 |
| Morbid Diagnoses | | |
| Number of medica- | 351 | 5.73 ± 3.3 |
| tions on discharge | | |
| Depression score | 259 | 11.44 ± 10.6 |
| admission [0-60] | | |
| Imputed Depression | 355 | 12.08 ± 9.5 |
| score admission | | |

### Statistical Analysis

Descriptive statistics revealed the distribution of the variables. Two cases were accidentally not posted for the experts, so the dataset contained 353 cases. Because depression was not assessed in Study one and assessed partially in Study three, 27.0% of the subjects did not have depression scores. Missing depression scores where imputed using multiple imputation via the EM method (Schafer, J. L. (1997). Analysis of incomplete multivariate data. In Chapman & Hall, Book No. 72, Chapman & Hall series Monographs on Statistics and Applied Probability. Boca Raton Chapman and Hall). Imputed variables were generated based on the known subject demographic and functional information at baseline, including age, race, gender, marital status, self-rated health, number of co-morbidities and functional status variables. Categorical variables were collapsed, as necessary, to ensure sufficient numbers (>5%) in any one category. Due to the number of variables to be considered, terms were added using forward selection, adding those factors whose addition caused a significant change in the model fit. Variables that were selected in the final models were reviewed to ensure there was no confounding. The final model contained all of the independent variables able to sustain statistical significance (P<0.05), or those whose removal affected the estimate for another significant variable by more than 10% (Hosmer, D. W., & Lemeshow, S. (2000). Applied logistic regression (2^{nd} ed.). New York: John Wiley and Sons). Receiver operating characteristic (ROC) curves were used to determine the optimal cut-point for classification/prediction by the regression model (Hanley & McNeil, 1982, Radiology, 143:29-36). Finally, Monte Carlo cross-validation was run to obtain overall predictive value, using 500 replications and 20% of the data as the validation set (Efron, B., & Tibshirani, R. J. (1993). An introduction to the bootstrap. New York: Chapman and Hall).

### Example 2 Results

Characteristics of the Sample were as follows: 54% were female, 74% white, 26% black, average age 74 (range 65-90), 50% married, 36% widowed, 30% had less than a high school education, 43% with an annual income <$20,000, 52% percent had at least one hospitalization in the previous six months.

The experts recommended referral for 183 additional patients than were actually referred by hospital clinicians. While the experts' referral recommendations were predominantly for skilled home care services (88%), a few patients were also referred to outpatient (8%) and inpatient rehabilitation (4%). This distribution precluded examination separately by site; however, identification of who should be flagged for referral, regardless of site, remained clinically important. Therefore, the presence or absence of a discharge referral, regardless of site, remained the dependent variable.

Six of the 20 variables were found to be statistically significant (P<0.05) (Table 7), and the patient's age was an effect modifier. It changed the estimates for self-rated health by >10%. Experts were more likely to refer patients who had no or intermittent help: OR=3.0, P=0.018, 95% CI=1.2, 7.3; major walking restrictions: OR=6.5, P=0.002, 95% CI=2.0, 20.9; less than excellent self-rated health (good health: OR=3.1, P=0.017, 95% CI=1.2, 7.7; fair/poor health: OR=4.0, P=0.005, 95% CI=1.5, 10.5); longer length of stay: OR=1.2 per day, P=0.004, 95% CI=1.0, 1.3; higher depression scores: OR=1.1, P=0.011, 95% CI=1.0, 1.1; or more co-morbidities: OR=1.2, P=0.010, 95% CI=1.1, 1.5.

TABLE 7
Final Logistic Regression Model for the Experts' Referral Decision

| | | | | | 95.0% C.I. | |
|---|---|---|---|---|---|---|
| Variable | Esti- | | P- | Odds of | for Odds | |
| (n = 255)¹ | mate | S.E. | value | Referral | Lower | Upper |
| How often Help | | | .018 | | | |
| is Available | | | | | | |
| Never/Intermittent | 1.084 | 0.458 | .018 | 2.96 | 1.204 | 7.263 |
| Whenever needed | (ref)² | | | (ref) | | |
| Walking Function | | | .044 | | | |
| No restriction | (ref)² | | | (ref) | | |
| Minor restriction | 0.437 | 0.363 | .229 | 1.55 | 0.760 | 3.153 |
| Major restriction | 1.868 | 0.598 | .002 | 6.47 | 2.004 | 20.899 |
| Subjective health | | | .016 | | | |
| rating | | | | | | |
| Excellent | (ref)² | | | (ref) | | |
| Good | 1.117 | 0.470 | .017 | 3.05 | 1.216 | 7.671 |
| Fair/Poor | 1.387 | 0.493 | .005 | 4.00 | 1.523 | 10.523 |
| Length of Stay | 0.137 | 0.048 | .004 | 1.15 | 1.043 | 1.259 |
| (days) | | | | | | |
| Depression Score | 0.061 | 0.024 | .011 | 1.06 | 1.014 | 1.115 |
| Age (years) | 0.050 | 0.030 | .102 | 1.05 | 0.990 | 1.115 |
| Number of Co- | 0.209 | 0.081 | .010 | 1.23 | 1.051 | 1.446 |
| morbidities | | | | | | |

¹sample decreased to 255 because of missing depression scores
²(ref) = reference group used in model

Similar results were obtained when subjects with imputed depression scores were excluded from the model, except that age obtained statistical significance (OR=1.1, P=0.037, 95% CI=1.0, 1.2). Combination factors (interactions) identified by the experts were examined. However, they either did not occur in a large enough quantity to include in the models or were not statistically significant.

ROC curves were used to determine the optimal cut-point for classification. The optimal cut-point was 0.69. This corresponded to a sensitivity and specificity of 87.6% and 65.2% respectively. The area under the curve (AUC) was 86.3%. In general, an AUC greater than 80% indicates a good model for classifying subjects with an outcome of interest against those without the outcome (Hanley & McNeil, 1982). The overall predictive value for the model was 83.2%, with a cross-validated predictive value of 80.1%.

These findings address an important component of care coordination, which is an Institute of Medicine and National Quality Forum priority (Adams, K., & Corrigan, J. M. (2003).

### Priority Areas for National Action: Transforming Health Care Quality.

Committee on Identifying Priority Areas for Quality Improvement, Board of Health Care Services, Institute of Medicine of the National Academies. Washington, D.C.: National Academies Press). The period surrounding hospital discharge is a busy time involving multiple disciplines often with little time for collaboration and careful deliberation (Shepperd, S., Parkes, J., McClaren, J., & Phillips, C. (2004). Discharge planning from hospital to home. Cochrane Database Systematic Reviews, 1, CD000313). In this study, experts in discharge planning provided the knowledge to build a classification model. Providing experts with comprehensive, high quality information from actual clinical cases and the time to carefully consider their decisions contributed to the identification of additional patients who might have benefited from referrals. It is important to note that 23% of the additional patients identified by experts, but not referred by hospital clinicians, were rehospitalized by 12 weeks (Bowles, et al, 2008, Medical Care, 46:158-166).

The resulting six factor model provides guidance to busy clinicians about some key patient characteristics that are associated with experts' decisions to refer. For example, the model suggests careful evaluation of walking ability because those with major walking restrictions were 6.5 times more likely to be referred. Multiple sources agree that physical function, which includes walking, is an important predictor of the need for post-acute care and outcomes. (Cornette et al., 2006, European Journal of Public Health, 16(2):203-208; Nsameluh, et al., 2007, Clinical Nurse Specialist. 21(4):214-219).

Length of stay (LOS) was identified as a predictor of a referral. The mean LOS was seven days which corresponds to the mean LOS during the time in which the majority of the study data was collected (mean 6.8 days in 1995). By 2005 the average length of stay fell to 5.4 days (Medicare Payment Advisory Commission. (2007). Acute inpatient services: Short-term hospitals, specialty psychiatric facilities. Section 7 Jun. 2007 Databook. Retrieved Aug. 1, 2008 from http://www.medpac.gov/chapters/Jun07DataBookSec7.pdf). However, even though the experts knew that the current LOS is likely to be lower, they still identified length of stay as an important factor because length of stay is often a proxy for severity of illness or complicated hospital course (Fogel, et al., 2000, Journal of the American Medical Directors Association, 1:202-210) or a predictor of poor outcomes (Cornette, et al., 2005, Aging-Clinical & Experimental Research, 17(4):322-328).

Advanced age (Holland, et al., 2006, Nursing Research, 55(1):62-71) and number of co-morbidities (Naylor, et al., 1999, Journal of the American Medical Association, 281:613-620; Naylor, et al., 2004, Journal of the American Geriatric Society, 52:675-84) are commonly associated with risk for poor outcomes. These factors are usually documented and readily available in the medical record. However, other factors such as depression and self-rated health have not been routinely measured in acute care. In addition, usually it is noted whether a patient has a caregiver or not. But these findings suggest that further probing into their availability is important.

The model is quite proficient (87.6% accurate) at predicting who should be referred but is suboptimal (65.2%) at classifying those who do not need a referral. The experts referred 183 additional patients than were referred in real life. Notably, in the 12 week outcome analysis, these patients were rehospitalized at a rate of 23% (Bowles, et al, 2008, Medical Care, 46:158-166). With a rehospitalization rate that high, it may be cost-effective to provide post-acute services for more patients if those services result in decreased future costs. Several studies suggest the clinical and economic value of correctly identifying patients and assuring appropriate follow-up care. (Naylor, et al., 1994, Annals of Internal Medicine, 120:999-1006; Naylor, et al., 1999, Journal of the American Medical Association, 281:613-620; Naylor, et al., 2004, Journal of the American Geriatric Society, 52:675-84; Bowles, et al, 2008, Medical Care, 46:158-166; Steeman, et al., 2006, Int J Qual Health Care 18(5):352-358). This remains an important area for future study.

### Example 3

### Application of the Discharge Decision Support System

The following study was made to test the effect of an evidence-based screening tool of the present invention, identified throughout this study as the Discharge Decision Support System (D²S²), that supports clinicians' discharge referral decision making by identifying high risk patients who need a referral for PAC (Bowles et al., 2009, Nursing Research. 58(2):115-122; Bowles et al., 2008, Medical Care 46(2):158-166). The study examined whether alerting hospital clinicians about high risk patients would result in better discharge plans as evidenced by time to first hospital readmission.

### Example 3 Methods

### Design

A quasi-experimental, two phase study was conducted on medical units at one urban, university medical center. The usual care phase was studied for eight months. Usual care included assessment for DP needs by unit-based discharge planners, and daily discharge rounds with physicians and staff nurses. Their assessments were guided by a self-developed assessment form and referral decision making was not structured and was made by individuals. The D²S² was collected by the research team to show how the patients scored on the D²S², but the results were not shared with clinicians. This phase was followed by staff education about the tool and implementation of a one year experimental phase when the advice from the D²S² tool was shared with the discharge planners to alert them of risk status (high-refer and low risk-do not refer) and to study impact on time to readmission. A prospective, patient level randomized, clinical trial was not possible because discharge planners are assigned to units and care for multiple patients on the same unit.

### Sample

Daily a list of admitted patients age 55 and older was supplied to trained nursing student or registered nurse research assistants (RAs). The RAs removed patients who did not speak English, were on dialysis, hospice, or were admitted from an institution (their PAC was predetermined). The remaining patients were approached and screened for cognitive impairment (CI) using the Animal Recall Test (Sebaldt et al., 2009, Canadian Journal of Neurological Sciences 36(5):599-604). Those cognitively intact gave their consent to participate. Those with a medical history of CI or who failed the Animal Recall Test were assented and their responsible caregiver provided consent and study information.

In the usual care phase 319 patients were enrolled. However, 38 were excluded in the final analysis for the following reasons: 17 had final diagnoses that were brief stays with uncomplicated discharge plans not in need of decision support, the team added these to the exclusion criteria for phase 2 (percutaneous procedure without stent, cardiac defibrillator implant without catheterization); 17 patients were missing the All Patient Refined Diagnostic Related Group (APR-DRG) score needed for severity adjustment; and four died before discharge. The final sample for analysis was 281.

In the experimental phase, 282 patients were enrolled. Thirty were excluded in the final analysis: 10 received the excluded diagnoses as a final diagnosis, five died before discharge, four had missing APR-DRG scores, and 11 did not have their scores properly shared (ie. missing or shared too late-after discharge). The final sample for analysis was 252.

### D²S²

The intervention was conducted using the D²S². The tool, as described hereinabove, identifies the characteristics of patients needing a referral and regression modeling and validation, thereby providing a predictive model of six factors associated with the expert PAC referral decision: age, walking ability, length of stay, number of co-morbid conditions, depression, and self rated health assessment (Bowles et al., 2009, Nursing Research. 58(2):115-122; Bowles et al., 2008, Medical Care 46(2):158-166). An optimal cut-off score based on the best sensitivity and specificity (AUC was 0.86) divides patients into two groups, do not refer or refer. As also described hereinabove, there is a version for patients who self-report (cognitively intact) and another for those who cannot that is collected from a caregiver.

### APR-DRG

Severity of illness was measured using the four APR-DRG subclasses (minor, moderate, major, extreme). The score is generated from diagnoses and procedure codes, age, gender, discharge date, status of discharge, and days on mechanical ventilator (Treo Solutions. Webinar: All patient refined DRGs (APR-DRGs): An overview Web site. http://www.bcbst.com/providers/webinar/APRDRG.pdf. Accessed 8/2012, 2012). The APR-DRG severity class was used as a control variable.

### Data Collection

RAs collected study data within 24-48 hours of hospital admission. In the usual care phase, socio-demographic, clinical information, and the D²S² were collected but were not shared with the clinicians. The same information was collected in the experimental phase and the D²S² advice was shared with the discharge planners. Subsequent hospital readmissions to the health system (three hospitals) were collected up to 60 days after the index discharge.

### Experimental Phase Procedures

Prior to the experimental phase of the study, the discharge planners and staff nurses were educated about the D²S², how it was developed, what the scores meant, and to bring the information to DP rounds. The decision support advice (D²S² scores and refer yes or no) was shared with clinicians for each enrolled patient via the electronic record. Every instance of information transfer was checked for accuracy to inclusion in the data analysis.

### Data Analysis

Subjects in each phase were stratified into two score groups, those who scored “do not refer” (low risk) and those who scored “refer” (high risk). Between- and within-phase comparisons were made. It was hypothesized that within the usual care phase, differences in outcome would be evident by score group, and within the experimental phase any differences would diminish due to improved decision making Inferential statistical analysis related to the efficacy of the decision tool would rely on the significance of the “group×phase” interaction term parameter estimate generated from the multivariate Cox proportional hazards model.

Subject characteristics were described using means and standard deviations for continuous variables, and frequencies and percents for categorical variables. Within group comparisons by D²S² referral status, as well as between group comparisons controlling for D²S² referral status, were accomplished using two-sample t-tests and Fisher's Exact tests for continuous and categorical measures, respectively. Adjusted survival curves and Cox proportional hazards model parameter estimates were used to evaluate, respectively, time to first hospital readmission by D²S² referral. Outcome was analyzed multivariately within each study period using Cox proportional hazards modeling, with control for APR-DRG class, clustering at the medical unit level and patient differences by phase. Variables incorporated into the D²S² factors (such as age and number of co-morbid conditions) and APR-DRG score (age, gender) were not included as control variables because of multicollinearity. Finally, to test for differences in patterns of hospital readmission by study phase, a comprehensive Cox regression model was generated with a group by D²S² referral interaction term, with adjustment for APR-DRG, significant control variables as described above, and clustering at the medical unit level.

### Example 3 Results

Comparison within Usual Care Phase

The most common diagnoses were heart failure, circulatory disorders with cardiac catheterization (with and without complication), and percutaneous cardiovascular (CV) procedure with major CV diagnosis. The mean age of the patients identified for referral was significantly older with a mean age 69.7 (SD=10.1), compared to those scored as do not refer (mean 67.3, SD=7.7), p=0.037. They also had significantly more medications (mean 10.4 vs 8.4 p=0.001), more co-morbid conditions (6.8 vs 5.7, p=0.003), saw their physicians more often (p=0.038), and had more frequent hospital admissions in the past six months (p<0.001) than do not refer patients. Additionally, APR-DRG severity levels were significantly higher among those identified as needing a referral (p<0.001). D²S² recommended referral for 61% and no referral for 39%.

Comparison within Experimental Phase

Similar to usual care phase patients, the most common diagnoses were heart failure, circulatory disorders with cardiac catheterization (with and without complication), and percutaneous cardiovascular (CV) procedure with major CV diagnosis. Again, the mean age of patients identified by the D²S² for referral was significantly older with a mean age of 70.7 versus 65.5 years, p<0.001), with more co-morbid conditions (mean 7.6 vs 6.5, p=0.039), more frequent hospital admissions in the past six months (p=0.030), and higher APR-DRG severity levels than do not refer patients (p<0.001). D²S² recommended referral for 69% and no referral for 31%.

### Comparison Between Phases: Do not Refer (Low Risk Patients)

There were no significant differences between do not refer patients in the usual care compared to do not refer patients in the experimental phase (Table 8).

TABLE 8
Characteristics of the D²S² Do Not Refer group by study
period (usual care phase compared to experimental)

| | Usual care | | Experimental | | |
|---|---|---|---|---|---|
| Variable | phase | | phase | | p |
| N | 110 | | 77 | | |
| Mean age (SD, median) | 67.3 | (7.65, 67) | 65.5 | (7.3, 65) | .116 |
| Mean number of medica- | 8.4 | (5.1, 8) | 9.84 | (5.2, 10) | .061 |
| tions (SD, median) | | | | | |
| Co-morbities (SD, median) | 5.7 | (2.9, 5) | 6.6 | (3.4, 6) | .069 |
| Male gender (%) | 67 | (60.9%) | 48 | (62.3%) | .843 |
| Ethnicity: non-Hispanic or | 109 | (99.1%) | 75 | (97.4) | .368 |
| Latino | | | | | |
| Race | | | | | .630 |
| American Indian or Alaska | 4 | (2.8) | 5 | (6.5%) | |
| Native or Asian or | | | | | |
| Hispanic (%) | | | | | |
| White (%) | 64 | (58.7%) | 50 | (64.9%) | |
| Black or African | 40 | (36.7%) | 22 | (28.6%) | |
| American (%) | | | | | |
| Other (%) | 2 | (1.8%) | — | | |
| Marital status | | | | | .194 |
| Divorced or separated or | 49 | (44.5%) | 27 | (35.1%) | |
| single or widowed (%) | | | | | |
| Married (%) | 61 | (55.5%) | 50 | (64.9%) | |
| Education | | | | | |
| Less than high school | 14 | (12.7%) | 9 | (11.7%) | |
| High school complete | 28 | (25.5%) | 27 | (35%) | |
| Some college/college | 67 | (60.9%) | 41 | (53.3%) | |
| Other | 1 | (.9%) | — | | |
| Insurance | | | | | .348 |
| Medicare | 38 | (34.6%) | 26 | (33.8%) | |
| Managed Medicare | 28 | (25.4%) | 12 | (15.5%) | |
| Medicaid | — | | — | | |
| Managed Medicaid | 5 | (4.6%) | 4 | (5.2%) | |
| Other Insurance | 39 | (35.4%) | 35 | (45.5%) | |
| Type of admission | | | | | .26 |
| Elective | 27 | (24.6%) | 12 | (15.6%) | |

| | Control | | Experimental | | |
|---|---|---|---|---|---|
| Variable | period | | period | | p |
| Emergency | 68 | (61.8%) | 56 | (72.7%) | |
| Transfer | 15 | (13.6%) | 9 | (11.7%) | |
| Physician visits during the | | | | | .601 |
| previous 6 months | | | | | |
| Not at all | 8 | (7.3%) | 4 | (5.2%) | |
| One time | 10 | (9.1%) | 4 | (5.2%) | |
| Two to three times | 22 | (20%) | 21 | (27.3%) | |
| Four to six times | 30 | (27.3%) | 24 | (31.2%) | |
| More than 6 times | 40 | (36.4%) | 24 | (31.2%) | |
| Overnight hospitalizations in | | | | | .529 |
| the past 6 months | | | | | |
| Not at all | 64 | (58.2%) | 52 | (67.5%) | |
| One time | 24 | (21.8%) | 14 | (18.2%) | |
| Two or three times | 15 | (13.6%) | 9 | (11.7%) | |
| More than 3 times | 7 | (6.4%) | 2 | (2.6%) | |
| APR-DRG severity of illness/ | | | | | .675 |
| risk of mortality group | | | | | |
| minor | 36 | (32.7%) | 19 | (24.6%) | |
| moderate | 42 | (38.2%) | 32 | (41.6%) | |
| major | 28 | (25.5%) | 22 | (28.6%) | |
| extreme | 4 | (3.6%) | 4 | (5.2%) | |

Abbreviations: SD, standard deviation; APR-DRG, all patient refined diagnosis related groups.

### Comparison Between Phases: Refer Patients (High Risk Patients)

Patients in the experimental phase of the study, with a D²S² refer status, had significantly more co-morbid conditions (mean 7.6 vs 6.8, p=0.024) and a higher proportion of emergency admissions (72% vs 54%, p<0.001) than in the usual care phase. However, patients in the usual care phase had a higher frequency of physician visits (52% vs 39% more than 6 times) and previous hospital admissions (36% vs 28% with 2 or more) than the experimental phase patients (Table 9).

TABLE 9
Characteristics of the D²S² Refer group by study period
(usual care phase compared to experimental)

| | Usual care | | Experimental | | |
|---|---|---|---|---|---|
| Variable | phase | | phase | | p |
| N | 171 | | 175 | | |
| Mean age (SD, median) | 69.7 | (10.1, 68) | 70.68 | (10.2, 69) | .352 |
| Mean number of medica- | 10.5 | (5.5, 10) | 10.3 | (5.4, 10) | .700 |
| tions (SD, median) | | | | | |
| Number of co-morbid | 6.8 | (2.9, 7) | 7.6 | (3.8, 7) | .024 |
| conditions (SD, median) | | | | | |
| Male gender (%) | 87 | (47.3%) | 97 | (52.7) | .396 |
| Ethnicity: non-Hispanic | 170 | (99.4%) | 171 | (97.7%) | .372 |
| or Latino | | | | | |
| Race | | | | | .088 |
| American Indian or Alaska | 2 | (1.2%) | 2 | (1.3%) | |
| Native or Asian or | | | | | |
| Hispanic (%) | | | | | |
| White (%) | 94 | (56.6%) | 109 | (64.5%) | |
| Black or African American | 70 | (42.2%) | 57 | (33.7%) | |
| (%) | | | | | |
| Other (%) | — | | 1 | (.6%) | |
| Marital status | | | | | .134 |
| Divorced or separated or | 89 | (52%) | 77 | (44%) | |
| single or widowed (%) | | | | | |
| Married (%) | 82 | (48%) | 98 | (56%) | |
| Education | | | | | .061 |
| Less than high school | 30 | (17.5%) | 31 | (17.7%) | |
| High school complete | 39 | (22.8%) | 59 | (33.7%) | |
| Some college/college | 109 | (59.7%) | 85 | (48.6%) | |
| Other | — | | — | | |
| Insurance | | | | | .137 |
| Medicare | 71 | (41.5%) | 95 | (54.3%) | |
| Managed Medicare | 39 | (22.8%) | 35 | (20%) | |
| Medicaid | 2 | (1.2%) | 2 | (1.1%) | |
| Managed Medicaid | 14 | (8.2%) | 7 | (4%) | |
| Other Insurance | 45 | (26.3%) | 36 | (20.6%) | |
| Type of admission | | | | | .000 |
| Elective | 38 | (22.2%) | 15 | (8.6%) | |
| Emergency | 92 | (53.8%) | 125 | (71.8%) | |
| Transfer | 41 | (24%) | 34 | (19.6%) | |
| Physician visits during | | | | | .026 |
| the previous 6 months | | | | | |
| Not at all | 3 | (1.7%) | 12 | (6.7%) | |
| One time | 13 | (7.6%) | 12 | (6.9%) | |
| Two to three times | 32 | (18.7%) | 32 | (18.3%) | |
| Four to six times | 35 | (20.5%) | 51 | (29.2%) | |
| More than 6 times | 88 | (51.5%) | 68 | (38.9%) | |
| Overnight hospitalizations | | | | | .034 |
| in the past 6 months | | | | | |
| Not at all | 59 | (34.5%) | 87 | (49.7%) | |
| One time | 51 | (29.8%) | 39 | (22.3%) | |
| Two or three times | 41 | (24%) | 30 | (17.1%) | |
| More than 3 times | 20 | (11.7%) | 19 | (10.9%) | |
| APR-DRG severity of | | | | | .319 |
| illness/risk of mortality | | | | | |
| group | | | | | |
| minor | 24 | (14.1%) | 19 | (10.9%) | |
| moderate | 65 | (38%) | 60 | (34.3%) | |
| major | 58 | (33.9%) | 59 | (33.7%) | |
| extreme | 24 | (14%) | 37 | (21.1%) | |

Abbreviations: SD, standard deviation; APR-DRG, all patient refined diagnosis related groups.

### Time to Readmission in Usual Care Phase

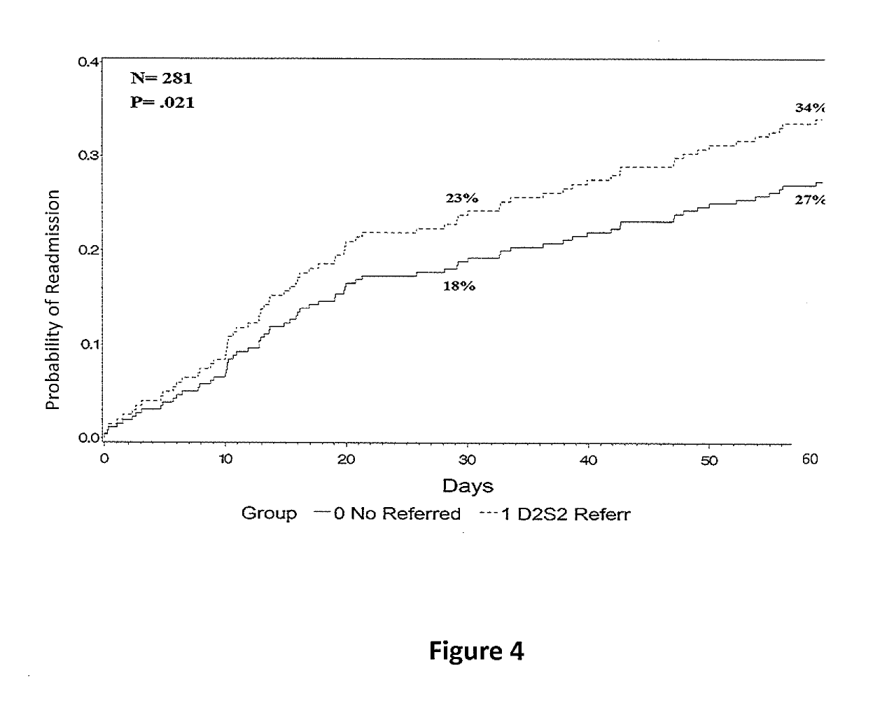

The time to readmission in the usual care group recommended for referral demonstrated an increased number of readmissions over time than the do not refer patients. The readmission rate for these patients at 30 days was 23% and at 60 days was 34%. The do not refer or low risk group 30 and 60 day readmissions reached 18% and 27%, respectively (FIG. 4). Adjusted difference between time to readmission for referral and non-referral patients was significant, with p=0.021.

Time to Readmission after Decision Support

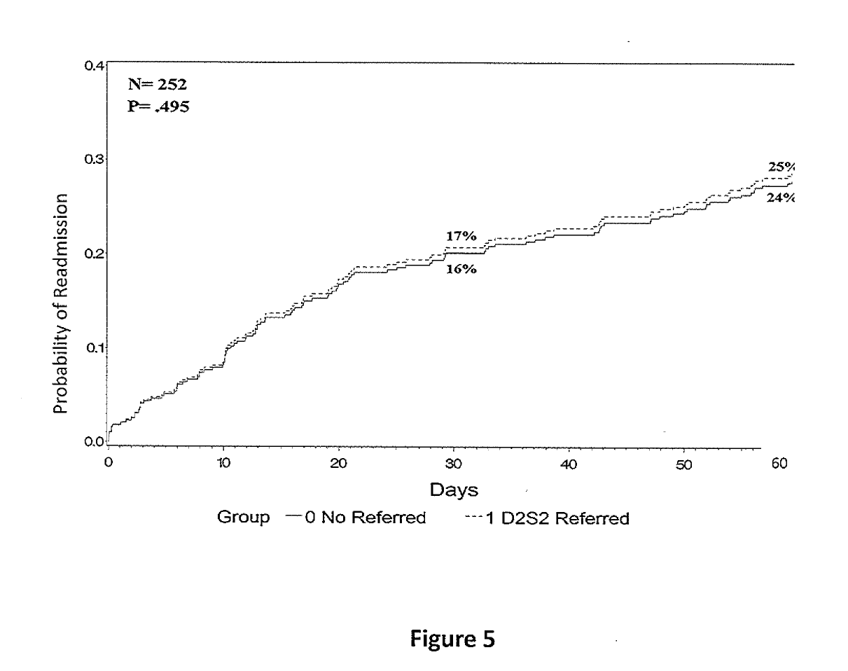

The time to readmission in the experimental phase patients recommended for referral showed a readmission rate at 30 and 60 days of 17% and 25%, respectively. The low risk or non-referral group 30 and 60 day readmissions reached 16% and 24%, respectively (FIG. 5). The adjusted difference between time to readmission for refer and do not refer patients was no longer significant, (p=0.495).

### Readmission Outcomes by Phase

After decision support, the percentage of refer or high risk patients readmitted by 30 and 60 days decreased by 6% and 9% respectively, representing a 26% relative reduction for both time periods. Additionally, the Cox proportional hazards model assessing differences in the patterns of hospital readmissions according to D²S² referral by study phase demonstrated significant differences in rates over time (p<0.0001), after adjusting for APR-DRG class, admission type, physician office visits, previous overnight hospitalization, and clustering at the medical unit level.

The above experimental results suggest that after sharing decision support from the D²S², time to readmission was extended for high risk patients decreasing the rates of readmission by 26% at both 30 and 60 day time points. The D²S² provides a standardized way to assess patients for characteristics commonly associated with inability to provide self care and risk of readmission. Factors on the tool such as mobility (Cornette et al., 2006, Eur J Public Health 16(2):203-208; Callen et al., 2004, Medsurg Nurs 13(3):156-63; Preyde et al., 2011, J Evidence-Based Social Work 8:445-468), depression (Preyde et al., 2011, J Evidence-Based Social Work 8:445-468; Rosati et al., 2003, Journal for Healthcare Quality 25(2):4-10; Mitchell et al., 2010, Journal of Hospital Medicine 5(7):378-384; Hasan et al., 2010, Journal of General Internal Medicine 25(3):211-9; Blaylock et al., 1992, Journal of Gerontological Nursing 18(7):5-10), number of co-morbid conditions (Preyde et al., 2011, J Evidence-Based Social Work 8:445-468; Rosati et al., 2003, Journal for Healthcare Quality 25(2):4-10; García-Pérez et al., 2011, QJM 104(8):639-651; Shalchi et al., 2009, Clinical Medicine 9(5):426-430), age (Preyde et al., 2011, J Evidence-Based Social Work 8:445-468; Anderson et al., 2005, Journal of Nursing Scholarship 37(1):73-79; van Walraven et al., 2010, Canadian Medical Association Journal 182(6):551-557), length of stay (Preyde et al., 2011, J Evidence-Based Social Work 8:445-468; Shalchi et al., 2009, Clinical Medicine 9(5):426-430; García-Pérez et al., 2011, QJM 104(8):639-651), and self-rated health (Boult et al., 1993, Journal of the American Geriatrics Society 41(8):811-817; Pacala et al., 1997, J Am Geriatr Soc 45(5):614-617) are frequently shown to be linked to the risk of readmissions. Based on how patients or caregivers answer the D²S² questions the combination of factors equate to the need for post-acute support to mitigate the risk of readmission. The significant differences on sociodemographic and clinical characteristics seen between low and high risk patients confirm the tool performed as expected in differentiating patients.

Evidence-based tools are much needed because nationally there is great variability in risk tolerance and decision making regarding referral decisions; some places over refer, wasting precious resources, while other under refer leaving patients without needed services. Further, evidence-based teams such as Coleman's Care Transitions (Coleman et al., 2006, Archives of Internal Medicine 166(17):1822-1828), project RED (Jack et al., 2009, Ann Intern Med 150(3):178-187), BOOSTing Care Transitions (BOOSTing Care Transitions Resource Room Project Team. The society of hospital medicine care transitions implementation guide: Project BOOST: Better Outcomes for Older adults through SafeTransitions. http://www.hospitalmedicine.org/ResourceRoomRedesign/RR_CareTransitions/html_CC/Implementation.cfm#. Updated 2008. Accessed Aug. 28, 2012), test and publish strategies to address weaknesses in discharge planning and transitions, but none recognized the importance of discharge referral decision making. As researchers and clinicians attempt to improve care coordination and transitions the D²S² contributes at a pivotal point in that process.

In the experimental phase when DPs used decision support, high risk patients achieved readmission rates similar to low risk patients and the difference in rates between high risk and low risk patients was no longer significant. The tool helped the discharge planners identify high risk patients early in the hospital stay and prompted them to meet PAC needs through more targeted teaching, case management, and appropriate referrals. Given this was a two phase study; another explanation may be that over time additional interventions were implemented that affected the readmission rates. However, hospital wide transitional care interventions were in place prior to the usual care phase, and remained stable throughout the experimental phase. The D²S² helped clinicians better target the right patients for those interventions. Further, statistical models were subsequently adjusted to account for any differences and clustering at the unit level was incorporated into the Cox modeling.

The BOOSTing Care Transitions program recognized that there are no externally validated tools to risk-stratify older patients transitioning out of the hospital. They compiled a ‘user-friendly’ risk tool of seven variables (BOOSTing Care Transitions Resource Room Project Team. The society of hospital medicine care transitions implementation guide: Project BOOST: Better Outcomes for Older adults through SafeTransitions. http://www.hospitalmedicine.org/ResourceRoomRedesign/RR_CareTransitions/html_CC/Implementation.cfm#. Updated 2008. Accessed Aug. 28, 2012). The BOOST protocol suggests that if any one of these variables exists, risk specific interventions should be considered. However, the majority of hospitalized patients are likely to screen in. As seen in the current study, the D²S² discriminates high and low risk patients. The D²S² is complementary to another screening tool, the Early Screen for Discharge Planning (ESDP) (Holland and Hemann, 2011, Joint Commission Journal on Quality & Patient Safety 37(1):29-36). The ESDP identifies patients who need comprehensive assessment by a discharge specialist versus those managed by the bedside nurse. Use of the ESDP engages discharge specialists while the D²S² assists another critical decision point, who to refer for PAC.

Standardized evidence based DP decision support, according to the system and methods of the present invention, will reform how referral decision making is conducted. This study attempted to standardize a common and important step in the DP process and showed an impact on time to readmission via application of the present invention through the D²S² tool.

The disclosures of each and every patent, patent application, and publication cited herein are hereby incorporated herein by reference in their entirety.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed:

1. A method of determining the need for a post-acute care service referral to a patient, comprising:
providing a plurality of questions relating to a patient, wherein each question has at least two selectable answers, and wherein each selectable answer has associated therewith a corresponding score;
receiving one of the selectable answers for each of the plurality of questions;
calculating a total score corresponding to the sum score of each of the answers selected; and
determining the need for a post-acute care referral based on whether the total score reaches a threshold value, wherein a total score above the threshold value is indicative of needing the post-acute care referral, and a total score at or below the threshold value is indicative of no need for a post-acute care referral.

2. The method of claim 1, wherein the plurality of questions relating to the patient are selected from the group consisting of the patient's: Ability to Walk, Self Rated Health Assessment, Length of Stay, Age, Number of Co-Morbid Conditions and Depression Rating.

3. The method of claim 2, wherein the plurality of questions relating to the patient include each of the patient's: Ability to Walk, Self Rated Health Assessment, Length of Stay, Age, Number of Co-Morbid Conditions and Depression Rating.

4. The method of claim 2, wherein the patient is cognitively intact or mildly cognitively impaired yet verbal.

5. The method of claim 3, wherein the patient is cognitively intact or mildly cognitively impaired yet verbal.

6. The method of claim 1, wherein the plurality of questions relating to the patient are selected from the group consisting of: How Often a Caregiver is Available to Care for the Patient, Ability to Walk, Self Rated Health Assessment, Length of Stay, Number of Co-Morbid Conditions and Patient Income.

7. The method of claim 6, wherein the plurality of questions relating to the patient include each of: How Often a Caregiver is Available to Care for the Patient, Ability to Walk, Self Rated Health Assessment, Length of Stay, Number of Co-Morbid Conditions and Patient Income.

8. The method of claim 7, wherein the patient is severely cognitively impaired or cannot speak.

9. The method of claim 8, wherein the patient is severely cognitively impaired or cannot speak.

10. The method of claim 1, wherein the method is executable on a computing device.

11. The method of claim 1, wherein the method is performed at the time of patient admission to a healthcare facility.

12. The method of claim 1, further comprising providing at least one follow-up question after the determination for the need for a post-acute care referral has been made.

13. A system for recommending post-acute care services to a patient, comprising:
providing a plurality of questions relating to a patient, wherein each question has at least two selectable answers, and wherein each selectable answer has associated therewith a corresponding score;
receiving one of the selectable answers for each of the plurality of questions;
calculating a total score corresponding to the sum score of each of the answers selected; and
generating a post-acute care referral if the total score meets a predetermined threshold value.

14. The system of claim 13, wherein the system is executable on a computing device.

15. The system of claim 13, wherein the plurality of questions relating to the patient are selected from the group consisting of the patient's: Ability to Walk, Self Rated Health Assessment, Length of Stay, Age, Number of Co-Morbid Conditions and Depression Rating.

16. The system of claim 15, wherein the plurality of questions relating to the patient include each of the patient's: Ability to Walk, Self Rated Health Assessment, Length of Stay, Age, Number of Co-Morbid Conditions and Depression Rating.

17. The system of claim 15, wherein the patient is cognitively intact or mildly cognitively impaired yet verbal.

18. The system of claim 16, wherein the patient is cognitively intact or mildly cognitively impaired yet verbal.

19. The system of claim 13, wherein the plurality of questions relating to the patient are selected from the group consisting of: How Often a Caregiver is Available to Care for the Patient, Ability to Walk, Self Rated Health Assessment, Length of Stay, Number of Co-Morbid Conditions and Patient Income.

20. The system of claim 19, wherein the plurality of questions relating to the patient include each of: How Often a Caregiver is Available to Care for the Patient, Ability to Walk, Self Rated Health Assessment, Length of Stay, Number of Co-Morbid Conditions and Patient Income.

21. The system of claim 19, wherein the patient is severely cognitively impaired or cannot speak.

22. The system of claim 20, wherein the patient is severely cognitively impaired or cannot speak.

23. The system of claim 13, wherein the system is performed at the time of patient admission to a healthcare facility.

24. The system of claim 13, further comprising providing at least one follow-up question after determining if the generation of a post-acute care referral was necessary.

25. An automated system for recommending post-acute care services to a patient, comprising a computing device having resident therein a computer executable recommendation engine, wherein the recommendation engine presents to a user of the computing device a plurality of questions relating to a patient, wherein each question has at least two selectable answers, and wherein each selectable answer has associated therewith a corresponding score, such that when an answer is selected for each of the plurality of questions, a total score corresponding to the sum score of each of the answers is calculated, and a post-acute care referral is recommended for the patient if the total score meets a predetermined threshold value.

26. A method of reducing the rate of readmission of a patient to a healthcare facility, comprising:
providing a plurality of questions relating to a patient being admitted to a healthcare facility, wherein each question has at least two selectable answers, and wherein each selectable answer has associated therewith a corresponding score;
receiving one of the selectable answers for each of the plurality of questions;
calculating a total score corresponding to the sum score of each of the answers selected; and
determining the need for a post-acute care referral based on whether the total score reaches a threshold value, wherein a total score above the threshold value is indicative of needing the post-acute care referral, and a total score at or below the threshold value is indicative of no need for a post-acute care referral;
wherein the determination of the need for a post-acute care referral reduces the rate of readmission of the patient to a healthcare facility.

27. The method of claim 26, wherein the plurality of questions relating to the patient are selected from the group consisting of the patient's: Ability to Walk, Self Rated Health Assessment, Length of Stay, Age, Number of Co-Morbid Conditions and Depression Rating.

28. The method of claim 27, wherein the plurality of questions relating to the patient include each of the patient's: Ability to Walk, Self Rated Health Assessment, Length of Stay, Age, Number of Co-Morbid Conditions and Depression Rating.

29. The method of claim 27, wherein the patient is cognitively intact or mildly cognitively impaired yet verbal.

30. The method of claim 28, wherein the patient is cognitively intact or mildly cognitively impaired yet verbal.

31. The method of claim 26, wherein the plurality of questions relating to the patient are selected from the group consisting of: How Often a Caregiver is Available to Care for the Patient, Ability to Walk, Self Rated Health Assessment, Length of Stay, Number of Co-Morbid Conditions and Patient Income.

32. The method of claim 31, wherein the plurality of questions relating to the patient include each of: How Often a Caregiver is Available to Care for the Patient, Ability to Walk, Self Rated Health Assessment, Length of Stay, Number of Co-Morbid Conditions and Patient Income.

33. The method of claim 32, wherein the patient is severely cognitively impaired or cannot speak.

34. The method of claim 33, wherein the patient is severely cognitively impaired or cannot speak.

35. The method of claim 26, wherein the method is executable on a computing device.

36. The method of claim 26, wherein the method is performed at the time of patient admission to a healthcare facility.

37. The method of claim 26, further comprising providing at least one follow-up question after the determination for the need for a post-acute care referral has been made.

38. The method of claim 26, wherein the relative rate of readmission of the patient to a healthcare facility is reduced by at least 10%.

39. The method of claim 26, wherein the relative rate of readmission of the patient to a healthcare facility is reduced by at least 15%.

40. The method of claim 26, wherein the relative rate of readmission of the patient to a healthcare facility is reduced by at least 20%.

41. The method of claim 26, wherein the relative rate of readmission of the patient to a healthcare facility is reduced by at least 25%.
